(19) United States
(12) Patent Application Publication
(10) Pub. No.: US 2025/0062819 A1
(43) Pub. Date: Feb. 20, 2025

(54) FAST BEAM SELECTION VIA USER EQUIPMENT RECEIVE BEAM SELECTION REPORTING

(71) Applicant: QUALCOMM Incorporated, San Diego, CA (US)

(72) Inventors: Jacob PICK, Mevaseret Zion (IL); Shay LANDIS, Hod Hasharon (IL); Peer BERGER, Hod Hasharon (IL)

(21) Appl. No.: 18/450,294

(22) Filed: Aug. 15, 2023

(51) Int. Cl. H04B 7/08; H04B 7/06

(52) U.S. Cl. CPC H04B 7/088; H04B 7/0628

(57) ABSTRACT

Methods, systems, and devices for fast beam selection via user equipment (UE) receive (Rx) beam selection reporting are described. A UE may transmit a beam selection report conveying a selected Rx beam, position, and orientation to a network entity. The network entity may build a database with the conveyed information. The network entity may “tag” each position for which a UE has transmitted a beam selection report and, if another UE gets close to a “tagged” position, the network entity may indicate the associated position, orientation, selected Rx beam, and a corresponding transmit (Tx) beam to that UE. The UE may use the information to select Tx and Rx beam search windows and window centers. Compared to other methods, the process described herein may result in a smaller search window, decreased complexity of the beam selection process, decreased power consumption, decreased latency, and more accurate tracking of UE dynamics.

### FIELD OF TECHNOLOGY

The following relates to wireless communication, including fast beam selection via user equipment (UE) receive (Rx) beam selection reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

A network entity (e.g., gNB) or a UE may be equipped with multiple antennas, which may be used to employ techniques such as transmit diversity, receive diversity, multiple-input multiple-output (MIMO) communications, or beamforming. The antennas of a network entity or a UE may be located within one or more antenna arrays or antenna panels, which may support MIMO operations or transmit or receive beamforming. A network entity may include an antenna array with a set of rows and columns of antenna ports that the network entity may use to support beamforming of communications with a UE. Likewise, a UE may include one or more antenna arrays that may support various MIMO or beamforming operations. Additionally, or alternatively, an antenna panel may support radio frequency (RF) beamforming for a signal transmitted via an antenna port.

### SUMMARY

The systems, methods, and devices of this disclosure each have several innovative aspects, no single one of which is solely responsible for the desirable attributes disclosed herein.

A method for wireless communication by a user equipment (UE) is described. The method may include transmitting an indication of a capability of the UE to communicate one or more beam selection reports, each beam selection report including information indicative of a current receive beam of the UE, a current position of the UE, and a current orientation of the UE, receiving, based on the capability of the UE, a request for a beam selection report from the UE, and transmitting the beam selection report based on the request, the beam selection report including information indicative of a first receive beam of the UE, a first position of the UE, and a first orientation of the UE.

A UE is described. The UE may include at least one processor, and at least one memory coupled with the at least one processor, with instructions stored in the at least one memory. The instructions may be executable by the at least one processor, individually or in any combination, to cause the UE to transmit an indication of a capability of the UE to communicate one or more beam selection reports, each beam selection report including information indicative of a current receive beam of the UE, a current position of the UE, and a current orientation of the UE, receive, based on the capability of the UE, a request for a beam selection report from the UE, and transmit the beam selection report based on the request, the beam selection report including information indicative of a first receive beam of the UE, a first position of the UE, and a first orientation of the UE.

Another UE is described. The UE may include means for transmitting an indication of a capability of the UE to communicate one or more beam selection reports, each beam selection report including information indicative of a current receive beam of the UE, a current position of the UE, and a current orientation of the UE, means for receiving, based on the capability of the UE, a request for a beam selection report from the UE, and means for transmitting the beam selection report based on the request, the beam selection report including information indicative of a first receive beam of the UE, a first position of the UE, and a first orientation of the UE.

A non-transitory computer-readable medium storing code for wireless communication at a UE is described. The code may include instructions executable by at least one processor, individually or in any combination, to transmit an indication of a capability of the UE to communicate one or more beam selection reports, each beam selection report including information indicative of a current receive beam of the UE, a current position of the UE, and a current orientation of the UE, receive, based on the capability of the UE, a request for a beam selection report from the UE, and transmit the beam selection report based on the request, the beam selection report including information indicative of a first receive beam of the UE, a first position of the UE, and a first orientation of the UE.

Some examples of the method, UEs, and non-transitory computer-readable medium described herein may further include operations, features, means, or instructions for receiving, based on the capability of the UE, a control message including information indicative of requested granularities for receive beams reported by the UE, positions reported by the UE, and orientations reported by the UE, where each of the first receive beam of the UE, the first position of the UE, and the first orientation of the UE may be in accordance with the requested granularities.

In some examples of the method, UEs, and non-transitory computer-readable medium described herein, the control message further includes information indicative of a granularity of a transmit beam, of a network entity, to be reported by the network entity.

In some examples of the method, UEs, and non-transitory computer-readable medium described herein, the beam selection report may be transmitted at a first time and the method, apparatuses, and non-transitory computer-readable medium may include further operations, features, means, or instructions for transmitting a second beam selection report at a second time based on a time periodicity associated with the one or more beam selection reports, the second beam selection report including information indicative of a second receive beam of the UE at the second time, a second position of the UE at the second time, and a second orientation of the UE at the second time.

In some examples of the method, UEs, and non-transitory computer-readable medium described herein, the beam selection report may be transmitted in accordance with one or both of the first position or the first orientation being within a threshold distance or orientation of a first tagged position or a first tagged orientation and the method, apparatuses, and non-transitory computer-readable medium may include further operations, features, means, or instructions for transmitting a second beam selection report based on one or both of a second position of the UE or a second orientation of the UE being within the threshold distance or orientation of a second tagged position or a second tagged orientation, respectively.

Some examples of the method, UEs, and non-transitory computer-readable medium described herein may further include operations, features, means, or instructions for receiving a second beam selection report based on the current position of the UE becoming within a threshold distance of a second position, the second beam selection report including information indicative of at least a transmit beam of a network entity and a receive beam corresponding to the transmit beam, transmitting an indication of a first set of parameters associated with beam selection at the UE, the first set of parameters being based on the transmit beam and the receive beam, and performing a beam selection procedure with the network entity based on the first set of parameters.

In some examples of the method, UEs, and non-transitory computer-readable medium described herein, the second beam selection report further includes information indicative of the second position, a second orientation, and a timestamp corresponding to a third beam selection report via which the receive beam, the second position, and the second orientation may be reported.

Some examples of the method, UEs, and non-transitory computer-readable medium described herein may further include operations, features, means, or instructions for selecting the first set of parameters based on the transmit beam, the receive beam, the second position, the second orientation, and the timestamp, where the first set of parameters include a transmit beam search window, a receive beam search window, a transmit beam window center, and a receive beam window center.

In some examples of the method, UEs, and non-transitory computer-readable medium described herein, the request may be received via a downlink control information (DCI) message and the beam selection report may be transmitted via an uplink control information (UCI) message.

In some examples of the method, UEs, and non-transitory computer-readable medium described herein, information indicative of the first position of the UE and information indicative of the first orientation of the UE includes coordinate information, elevation information, azimuth information, or any combination thereof, and information indicative of the first receive beam includes an indication of a quantity of receive antennas.

A method for wireless communication by a UE is described. The method may include receiving a first beam selection report based on a proximity of the UE to a first position, the first beam selection report including information indicative of at least a first transmit beam of a network entity and a first receive beam corresponding to the first transmit beam, transmitting an indication of a first set of parameters associated with beam selection at the UE, the first set of parameters being based on the first transmit beam and the first receive beam, and performing a beam selection procedure with the network entity based on the first set of parameters.

A UE is described. The UE may include at least one processor, and at least one memory coupled with the at least one processor, with instructions stored in the at least one memory. The instructions may be executable by the at least one processor, individually or in any combination, to cause the UE to receive a first beam selection report based on a proximity of the UE to a first position, the first beam selection report including information indicative of at least a first transmit beam of a network entity and a first receive beam corresponding to the first transmit beam, transmit an indication of a first set of parameters associated with beam selection at the UE, the first set of parameters being based on the first transmit beam and the first receive beam, and perform a beam selection procedure with the network entity based on the first set of parameters.

Another UE is described. The UE may include means for receiving a first beam selection report based on a proximity of the UE to a first position, the first beam selection report including information indicative of at least a first transmit beam of a network entity and a first receive beam corresponding to the first transmit beam, means for transmitting an indication of a first set of parameters associated with beam selection at the UE, the first set of parameters being based on the first transmit beam and the first receive beam, and means for performing a beam selection procedure with the network entity based on the first set of parameters.

A non-transitory computer-readable medium storing code for wireless communication at a UE is described. The code may include instructions executable by at least one processor, individually or in any combination, to receive a first beam selection report based on a proximity of the UE to a first position, the first beam selection report including information indicative of at least a first transmit beam of a network entity and a first receive beam corresponding to the first transmit beam, transmit an indication of a first set of parameters associated with beam selection at the UE, the first set of parameters being based on the first transmit beam and the first receive beam, and perform a beam selection procedure with the network entity based on the first set of parameters.

In some examples of the method, UEs, and non-transitory computer-readable medium described herein, the first beam selection report further includes information indicative of the first position, a first orientation, and a first timestamp corresponding to a second beam selection report via which the first receive beam, the first position, and the first orientation may be reported.

Some examples of the method, UEs, and non-transitory computer-readable medium described herein may further include operations, features, means, or instructions for selecting the first set of parameters based on the first transmit beam, the first receive beam, the first position, the first orientation, and the first timestamp, where the first set of parameters include a first transmit beam search window, a first receive beam search window, a first transmit beam window center, and a first receive beam window center.

In some examples of the method, UEs, and non-transitory computer-readable medium described herein, respective sizes of the first transmit beam search window and the first receive beam search window may be associated with the proximity of a current position of the UE to the first position, a similarity of a current orientation of the UE to the first orientation, and a time duration between the first timestamp and a time at which the first beam selection report may be received by the UE.

In some examples of the method, UEs, and non-transitory computer-readable medium described herein, the first transmit beam window center may be the first transmit beam and the first receive beam window center may be the first receive beam.

In some examples of the method, UEs, and non-transitory computer-readable medium described herein, information indicative of the first position and information indicative of the first orientation includes coordinate information, elevation information, azimuth information, or any combination thereof, and information indicative of the first receive beam includes an indication of a quantity of receive antennas.

Some examples of the method, UEs, and non-transitory computer-readable medium described herein may further include operations, features, means, or instructions for receiving a second beam selection report based on the UE becoming within a threshold distance to a second position, the second beam selection report including information indicative of at least a second transmit beam of the network entity and a second receive beam corresponding to the second transmit beam, transmitting an indication of a second set of parameters associated with the beam selection at the UE, the second set of parameters being based on the second transmit beam and the second receive beam, and performing a second beam selection procedure with the network entity based on the second set of parameters associated with the beam selection at the UE.

Some examples of the method, UEs, and non-transitory computer-readable medium described herein may further include operations, features, means, or instructions for transmitting an indication of a capability of the UE to communicate one or more beam selection reports, each beam selection report including information indicative of a current receive beam of the UE, a current position of the UE, and a current orientation of the UE, receiving, based on the capability of the UE, a request for a beam selection report from the UE, and transmitting the beam selection report based on the request, the beam selection report including information indicative of a second receive beam of the UE, a second position of the UE, and a second orientation of the UE.

Some examples of the method, UEs, and non-transitory computer-readable medium described herein may further include operations, features, means, or instructions for receiving, based on the capability of the UE, a control message including information indicative of requested granularities for receive beams reported by the UE, positions reported by the UE, and orientations reported by the UE, where each of the second receive beam of the UE, the second position of the UE, and the second orientation of the UE may be in accordance with the requested granularities.

In some examples of the method, UEs, and non-transitory computer-readable medium described herein, the UE receives the first beam selection report based on a current position of the UE becoming within a threshold distance to the first position.

A method for wireless communication by a network entity is described. The method may include receiving an indication of a capability of a UE to communicate one or more beam selection reports, each beam selection report including information indicative of a current receive beam of the UE, a current position of the UE, and a current orientation of the UE, transmitting, based on the capability of the UE, a request for a beam selection report from the UE, and receiving, based on the request, the beam selection report including information indicative of a first receive beam of the UE, a first position of the UE, and a first orientation of the UE.

A network entity is described. The network entity may include at least one processor, and at least one memory coupled with the at least one processor, with instructions stored in the at least one memory. The instructions may be executable by the at least one processor, individually or in any combination, to cause the network entity to receive an indication of a capability of a UE to communicate one or more beam selection reports, each beam selection report including information indicative of a current receive beam of the UE, a current position of the UE, and a current orientation of the UE, transmit, based on the capability of the UE, a request for a beam selection report from the UE, and receive, based on the request, the beam selection report including information indicative of a first receive beam of the UE, a first position of the UE, and a first orientation of the UE.

Another network entity is described. The network entity may include means for receiving an indication of a capability of a UE to communicate one or more beam selection reports, each beam selection report including information indicative of a current receive beam of the UE, a current position of the UE, and a current orientation of the UE, means for transmitting, based on the capability of the UE, a request for a beam selection report from the UE, and means for receiving, based on the request, the beam selection report including information indicative of a first receive beam of the UE, a first position of the UE, and a first orientation of the UE.

A non-transitory computer-readable medium storing code for wireless communication at a network entity is described. The code may include instructions executable by at least one processor, individually or in any combination, to receive an indication of a capability of a UE to communicate one or more beam selection reports, each beam selection report including information indicative of a current receive beam of the UE, a current position of the UE, and a current orientation of the UE, transmit, based on the capability of the UE, a request for a beam selection report from the UE, and receive, based on the request, the beam selection report including information indicative of a first receive beam of the UE, a first position of the UE, and a first orientation of the UE.

Some examples of the method, network entities, and non-transitory computer-readable medium described herein may further include operations, features, means, or instructions for storing information associated with the beam selection report in a database of the network entity, where the network entity associates, via the database, the first receive beam of the UE and a first transmit beam of the network entity used to communicate with the UE with the first position of the UE, the first orientation of the UE, and a first timestamp at which the beam selection report may be received.

Some examples of the method, network entities, and non-transitory computer-readable medium described herein may further include operations, features, means, or instructions for transmitting, to a second UE, a second beam selection report based on a second position of the second UE becoming within a threshold distance of the first position, the second beam selection report including information indicative of at least the first transmit beam and the first receive beam, receiving an indication of a first set of parameters associated with beam selection at the second UE, the first set of parameters being based on the first transmit beam and the first receive beam, and performing a beam selection procedure with the second UE based on the first set of parameters.

In some examples of the method, network entities, and non-transitory computer-readable medium described herein, the second beam selection report further includes information indicative of the first position, the first orientation, and the first timestamp.

In some examples of the method, network entities, and non-transitory computer-readable medium described herein, the first set of parameters include a first transmit beam search window, a first receive beam search window, a first transmit beam window center, and a first receive beam window center.

In some examples of the method, network entities, and non-transitory computer-readable medium described herein, respective sizes of the first transmit beam search window and the first receive beam search window may be associated with a proximity of the second position of the second UE to the first position, a similarity of a second orientation of the second UE to the first orientation, and a time duration between the first timestamp and a time at which the second beam selection report may be received by the second UE.

In some examples of the method, network entities, and non-transitory computer-readable medium described herein, the first transmit beam window center may be the first transmit beam and the first receive beam window center may be the first receive beam.

Some examples of the method, network entities, and non-transitory computer-readable medium described herein may further include operations, features, means, or instructions for transmitting, to the UE and based on the capability of the UE, a control message including information indicative of requested granularities for receive beams reported by the UE, positions reported by the UE, and orientations reported by the UE, where each of the first receive beam of the UE, the first position of the UE, and the first orientation of the UE may be in accordance with the requested granularities.

In some examples of the method, network entities, and non-transitory computer-readable medium described herein, the control message further includes information indicative of a granularity of a transmit beam, of the network entity, to be reported by the network entity.

In some examples of the method, network entities, and non-transitory computer-readable medium described herein, the beam selection report may be received at a first time and the method, apparatuses, and non-transitory computer-readable medium may include further operations, features, means, or instructions for receiving a second beam selection report at a second time based on a time periodicity associated with the one or more beam selection reports, the second beam selection report including information indicative of a second receive beam of the UE at the second time, a second position of the UE at the second time, and a second orientation of the UE at the second time.

In some examples of the method, network entities, and non-transitory computer-readable medium described herein, the beam selection report may be received in accordance with one or both of the first position or the first orientation being within a threshold distance or orientation of a first tagged position or a first tagged orientation and the method, apparatuses, and non-transitory computer-readable medium may include further operations, features, means, or instructions for receiving a second beam selection report based on one or both of a second position of the UE or a second orientation of the UE being within the threshold distance or orientation of a second tagged position or a second tagged orientation, respectively.

Some examples of the method, network entities, and non-transitory computer-readable medium described herein may further include operations, features, means, or instructions for receiving a set of multiple beam selection reports from a set of multiple UEs including the UE, each of the set of multiple beam selection reports including information indicative of a respective current receive beam, a respective current position, and a respective current orientation of each respective UE of the set of multiple UEs, generating a map associated with a set of multiple positions and a set of multiple orientations in accordance with the set of multiple beam selection reports, where the map associates a position and orientation pair to a UE receive beam and a network entity transmit beam, and transmitting one or more beam selection reports to one or more UEs of the set of multiple UEs, respectively, in accordance with the one or more UEs moving to one or more positions of the set of multiple positions, respectively.

In some examples of the method, network entities, and non-transitory computer-readable medium described herein, the request may be transmitted via a DCI message and the beam selection report may be received via a UCI message.

In some examples of the method, network entities, and non-transitory computer-readable medium described herein, information indicative of the first position of the UE and information indicative of the first orientation of the UE includes coordinate information, elevation information, azimuth information, or any combination thereof, and information indicative of the first receive beam includes an indication of a quantity of receive antennas.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIGS. 1 and 2 show examples of wireless communications systems that support fast beam selection via user equipment (UE) receive (Rx) beam selection reporting in accordance with one or more aspects of the present disclosure.

FIG. 3 shows an example of a process flow that supports fast beam selection via UE Rx beam selection reporting in accordance with one or more aspects of the present disclosure.

FIGS. 4 and 5 show block diagrams of devices that support fast beam selection via UE Rx beam selection reporting in accordance with one or more aspects of the present disclosure.

FIG. 6 shows a block diagram of a communications manager that supports fast beam selection via UE Rx beam selection reporting in accordance with one or more aspects of the present disclosure.

FIG. 7 shows a diagram of a system including a device that supports fast beam selection via UE Rx beam selection reporting in accordance with one or more aspects of the present disclosure.

FIGS. 8 and 9 show block diagrams of devices that support fast beam selection via UE Rx beam selection reporting in accordance with one or more aspects of the present disclosure.

FIG. 10 shows a block diagram of a communications manager that supports fast beam selection via UE Rx beam selection reporting in accordance with one or more aspects of the present disclosure.

FIG. 11 shows a diagram of a system including a device that supports fast beam selection via UE Rx beam selection reporting in accordance with one or more aspects of the present disclosure.

FIGS. 12 through 14 show flowcharts illustrating methods that support fast beam selection via UE Rx beam selection reporting in accordance with one or more aspects of the present disclosure.

### DETAILED DESCRIPTION

The following description is directed to some implementations for the purposes of describing the innovative aspects of this disclosure. However, a person having ordinary skill in the art will readily recognize that the teachings herein can be applied in a multitude of different ways. The described implementations may be implemented in any device, system, or network that is capable of transmitting and receiving radio frequency (RF) signals according to any of the Institute of Electrical and Electronics Engineers (IEEE) 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IoT) network, such as a system utilizing third generation (3G), fourth generation (4G) or fifth generation (5G), sixth generation (6G), or further implementations thereof, technology.

The process of beam selection between a network entity and a user equipment (UE) involves selecting both one or more transmit (Tx) beams and one or more receive (Rx) beams. The network entity (e.g., a gNB) and the UE may try many Tx-Rx combinations before selecting a Tx-Rx combination. If the network entity and UE communicate via relatively higher frequency bands (e.g., sub-terahertz (THz) frequency bands) with relatively narrower beams, the quantity of Tx-Rx combinations may increase. In other words, as compared to beam selection for communication via relatively lower frequency bands, the network entity and the UE may try relatively more combinations of Tx-Rx beams before selecting a Tx-Rx combination for further communication, as there may be relatively more candidate (such as potential) Tx-Rx beam combinations. As the quantity of candidate Tx-Rx beam combinations increases, the complexity of the beam selection process may increase, which may result in increased power consumption during the beam selection process and increased latency of the beam selection process.

In accordance with examples described herein, a network entity and one or more UEs may establish (such as identify, select, or otherwise determine) Tx-Rx beam combinations at the one or more UEs and, as the one or more UEs change positions and/or orientations within a coverage area served by the network entity, the network entity may build a database of beam selection parameters in accordance with beam selection reporting by each of the one or more UEs. For example, in accordance with time periodicity-based beam selection reporting and/or UE position-based beam selection reporting, a UE may transmit a beam selection report to the network entity including information indicative of an Rx beam currently used by the UE, a current position of the UE, and a current orientation of the UE. The network entity may identify a Tx beam corresponding to the reported Rx beam (which the network entity may already have information of) and may save (such as store) such information in the database. The network entity may receive multiple of such beam selection reports from one or more UEs at different positions and/or orientations and may build the database over time based on the multiple beam selection reports. As such, the database may include information indicative of a respective Tx-Rx beam combination corresponding to a respective UE position and/or a respective UE orientation. Each UE position and UE orientation for which the network entity has saved a corresponding Tx-Rx beam combination may be referred to as a tagged position and a tagged orientation, respectively.

The network entity may use the database to assist beam searching UEs by enabling a beam searching UE to perform a beam selection procedure using a relatively smaller quantity of candidate Tx-Rx beam combinations (as compared to a quantity of candidate Tx-Rx beam combinations that the UE might otherwise measure). For example, if a UE becomes within a threshold distance of a tagged position in the database, the network entity may transmit a beam selection report to the UE including information indicative of the tagged position, an orientation, and a Tx-Rx beam combination corresponding to the tagged position and orientation. In other words, if a UE becomes within a threshold distance of a tagged position, the network entity may transmit previously reported beam selection information to the UE, which may be relevant to the UE on the basis of the UE being in a similar position as a previously reporting UE was at the time the previously reporting UE transmitted a beam selection report (as the UE and the previously reporting UE may have some likelihood of using same or similar beams in accordance with being located in a same or similar position relative to the network entity). In some aspects, a beam selection report transmitted by the network entity may further include a timestamp indicating a time at which a corresponding beam selection report was received from a previously reporting UE.

A UE that receives a beam selection report from the network entity may use the position, orientation, Tx-Rx beam combination, and/or timestamp indicated by the beam selection report to select one or more beam search windows (such as a Tx beam search window and/or an Rx beam search window) and one or more corresponding window centers. In some implementations, the UE may use the Tx-Rx beam combination indicated by the beam selection report as the window centers and may scale a size of the one or more beam search windows in accordance with how far the UE is from the position indicated by the beam selection report, how similar a current orientation of the UE is to the orientation indicated by the beam selection report, or the timestamp indicated by the beam selection report, or any combination thereof. Respective sizes of the selected beam search window(s) may be relatively smaller than the UE may have otherwise used (such as without receiving the beam selection report from the network entity), which may reduce the complexity of the beam selection process and result in decreased power consumption and lower latency as compared to other beam selection processes. The example implementations of the present disclosure also allow for more accurate tracking of the dynamics of the UE (e.g., mobility and/or rotation, among other example UE dynamics), which may further support greater spectral efficiency, higher data rates, and greater system capacity, among other benefits.

Aspects of the disclosure are initially described in the context of wireless communications systems. Aspects of the disclosure are also described in the context of a process flow. Aspects of the disclosure are further illustrated by and described herein with reference to apparatus diagrams, system diagrams, and flowcharts that relate to fast beam selection via UE Rx beam selection reporting.

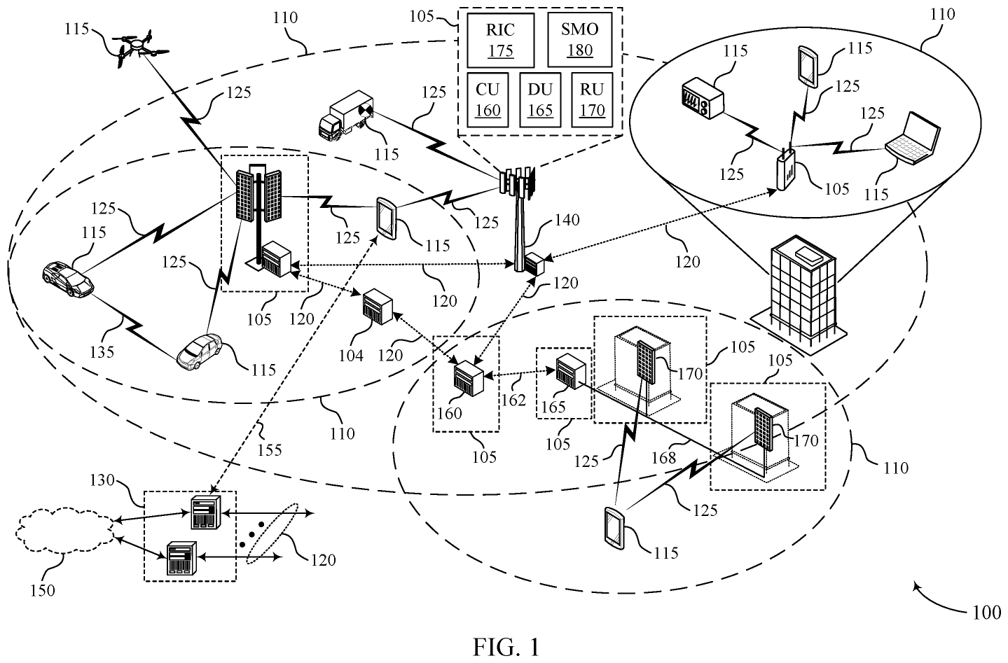

FIG. 1 shows an example of a wireless communications system 100 that supports fast beam selection via UE Rx beam selection reporting in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c. F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support fast beam selection via UE Rx beam selection reporting as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to any combination of an RF spectrum resource, a time resource, and a spatial resource (e.g., a spatial layer, a beam), and the use of multiple spatial resources may increase the data rate or data integrity for communications with a UE 115. The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use any combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described herein with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

A network entity 105 and one or more UEs 115 may be equipped with multiple antennas and may support beamforming. The network entity 105 may be in communication with multiple UEs 115 at a time. The network entity 105 may have a distinct Tx beam configuration for communication with each UE 115. In some implementations, the network entity 105 may build a database of beam selection parameters such that the network entity 105 and a UE 115 may reduce a quantity of candidate Tx-Rx beam combinations tried before selecting a Tx-Rx beam combination for further communication. In other words, the network entity 105 may use the database to expediate a beamforming process (such as a beam selection procedure). In some examples, a UE 115 may communicate (such as report or transmit) UE beam parameters via a beam selection report, such as a selected Rx beam, a current position of the UE 115 (e.g., a geographic coordinate location, a distance from the network entity 105, and/or an elevation), and a current orientation of the UE 115 (e.g., including or represented by an azimuth and/or an elevation), according to a granularity requested by the network entity 105. In some examples, the granularity may be predefined. A UE 115 may transmit a beam selection report conveying a selected Rx beam, a current position, and a current orientation to the network entity 105 at a predefined time periodicity or in accordance with a physical location periodicity (e.g., in a UE position-based manner). Accordingly, a UE 115 can transmit one or multiple beam selection reports and contribute to the database one or multiple times. The network entity 105 may “tag” parameters associated with the UE 115, such as a selected Tx beam, the reported position of the UE 115, the reported orientation of the UE 115, and a timestamp (e.g., a timestamp indicative of when the UE 115 transmits the beam selection report, when the network entity 105 receives the report, when the Tx-Rx beam combination is selected, or when the Tx-Rx beam combination was last used) for each report. The network entity 105 may store the beam selection report parameters and the tagged parameters in the database.

When a second UE 115 (e.g., the same UE 115 that had previously communicated the report and since moved away from the corresponding tagged position or a different UE 115) comes within a threshold distance of the tagged position stored in the database, the network entity 105 may indicate the position (e.g., geographic coordinate location, distance from the network entity 105, and/or elevation), orientation (e.g., azimuth and/or elevation), selected Rx beam, the selected Tx beam corresponding to the selected Rx beam, and the timestamp to the second UE 115. In other words, when a UE 115 is located within a threshold range of a tagged position (e.g., a position at which the network entity 105 has stored beam selection report parameters and tagged parameters), the network entity 105 may transmit relevant, previously reported information to the UE 115. The UE 115 may then use this information to select one or more beam search windows and one or more corresponding window centers. A selected search window may be a smaller window than the UE 115 may have otherwise used, which decreases the complexity of the beam selection process and results in decreased power consumption and decreased latency compared to other beam selection processes. Example implementations described herein also allow for or otherwise support more accurate tracking of the dynamics of the UEs 115 (e.g., mobility, rotation), among other benefits.

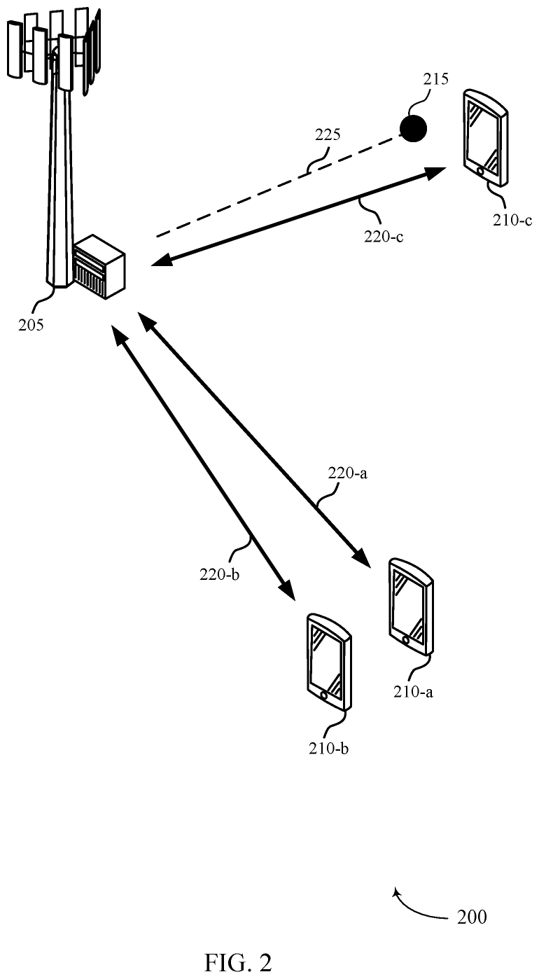

FIG. 2 shows an example of a wireless communications system 200 that supports fast beam selection via UE Rx beam selection reporting in accordance with one or more aspects of the present disclosure. The wireless communications system 200 may include a network entity 205 (which may be an example of a network entity 105 as illustrated by and described herein with reference to FIG. 1), UEs 210 (each of which may be an example of a UE 115 as illustrated by and described herein with reference to FIG. 1), and a tagged position 215. The network entity 205 may communicate with a UE 210-a via a communication link 220-a, with a UE 210-b via a communication link 220-b, and with a UE 210-c via a communication link 220-c. The network entity 205 may have previously communicated with a UE (such as the UE 210-a, the UE 210-b, or the UE 210-c) via a previous communication link 225 (e.g., when the UE was previously located at the tagged position 215). The communication links 220 may correspond to the communication links 125 as illustrated by and described herein with reference to FIG. 1.

In some systems, a process of beam selection at a UE 210 may involve selection of a combination of both a Tx beam and an Rx beam, which may become increasingly complex as the process may be associated with scanning potentially many Tx-Rx beam combinations. Further, as wireless communication devices (such as the network entity 205 or a UE 210) communicate via increasingly higher frequency bands (e.g., including sub-THz frequency bands) at which such wireless communication devices may use relatively narrower (e.g., more focused) beams, the quantity of candidate Tx-Rx beam combinations that a wireless communication may scan further increases (and may become prohibitively costly, in terms of latency or power consumption, for some types of wireless communication devices). As such, it may be desirable to simplify the beam selection process, as such simplification may provide benefits including reducing power consumption, speeding up an acquisition of a communication beam (e.g., acquisition of the beam process), and more accurate tracking of UE dynamics (e.g., mobility and/or rotation).

In accordance with aspects of the present disclosure, various wireless communication devices (e.g., the network entity 205 and the UEs 210) may speed up a beam selection procedure by using beam selection information of other UEs 210 that are (or were) in a close (e.g., nearby, such as within a threshold) physical location as a UE 210 currently searching/scanning for a suitable Rx beam to use for communication with the network entity 205. In some implementations, at some defined periodicity (e.g., a time periodicity or a physical location periodicity), each UE 210 may report, to the network entity 205, a selected Rx beam at that UE 210 (which may include information indicative of or may otherwise be associated with a quantity of Rx antennas), a current azimuth of that UE 210, and a current elevation of that UE 210. In other words, each beam selection report transmitted by a UE 210 may include information indicative of an Rx beam index, a quantity of antennas, an azimuth index, an elevation index, or any combination thereof. In some aspects, the Rx beam index may include or otherwise indicate the quantity of antennas (e.g., a quantity of Rx antennas, antenna modules, antenna panels, antenna elements, or any combination thereof) that were used by the reporting UE 210. The network entity 205 may “tag,” at a defined granularity, information including a selected Tx beam (which may be known to the network entity 205), the selected Rx beam, the UE azimuth, the UE elevation, the UE position, and a timestamp (of the report received by the network entity 205). Such a selected Tx beam may be a Tx beam used by a reporting UE 210 to transmit to the network entity 105, or may be a Tx beam used by the network entity 205 to transmit to the reporting UE 210.

Thereafter, whenever a (same or different) UE 210 comes within a close enough range to (e.g., within a threshold distance of) the tagged position, the network entity may send, to the UE 210, the previously tagged information that is relevant for the position of the UE 210. In some aspects, such a threshold distance within which the network entity 205 may transmit the previously tagged information may be defined by a network specification or may be indicated via radio resource control (RRC) signaling, a medium access control (MAC) control element (CE), downlink control information (DCI), or any combination thereof. The UE 210 may decide to use this information for speeding up a beam selection process at the UE 210, for example, if a current orientation of the UE 210 (e.g., an azimuth and/or elevation of the UE 210) is similar enough to the orientation indicated by network entity 205. Additionally, or alternatively, the UE 210 may decide to use this information if the timestamp associated with the report provided by the network entity 205 is within a threshold amount of time to a current time (such as if the report provided by the network entity 205 is sufficiently recent and not stale).

The UE 210 may use such information to speed up beam selection by using such information to select a size of one or more beam search windows for one or both of Tx and Rx beams. For example, a fast selection process may include a search window of the Tx and Rx beams, where respective sizes of the search windows may depend on an expected relevance of the report from the network entity 205 to the UE 210. In such examples, a higher confidence of relevancy may result in the UE 210 selecting relatively smaller search windows and a lower confidence of relevancy may result in the UE 210 selecting relatively larger search windows. For example, the UE 210 may select relatively smaller search windows if the UE 210 has a relatively more similar orientation to the reported orientation or if the timestamp is relatively more recent, or both, and may select relatively larger search windows if the UE 210 has a relatively more different orientation to the reported orientation or if the timestamp is relatively less recent, or both. Additionally, or alternatively, the selected sizes of the search windows may depend on how close the UE 210 is to the reported position. As such, the UE 210 may select sizes of search windows based on any combination or weighting, including a zero weighting, of position proximity, orientation similarity, or recency.

In some aspects, the network entity 205 and the UEs 210 may support capability signaling associated with such fast beam selection assisted by previously tagged information. For example, the UE 210-a may transmit, to the network entity 205 (e.g., a gNB), an indication of a capability of the UE 210-a to communicate one or more beam selection reports. The UE 210-a may transmit an indication of the capability of the UE 210-a via an uplink control information (UCI) message, a MAC-CE, an RRC message, or any combination thereof. Each beam selection report may include information indicative of a current Rx beam of the UE 210-a, a current position of the UE 210-a (e.g., coordinate information or a distance to the network entity 205), and a current orientation (e.g., azimuth, elevation) of the UE 210-a.

The network entity 205 may transmit, to the UE 210-a and based on the capability of the UE 210-a, a request for a beam selection report (e.g., information indicative of the current Rx beam, the current position, and the current orientation of the UE 210-a). The network entity 205 may transmit the request in accordance with a time periodicity (e.g., according to a time interval) or in accordance with the UE 210-a moving to a specific location. The network entity 205 may transmit the request as a control message (e.g., a DCI message). The network entity 205 may also specify a requested granularity for the Rx beam, the current position, and the current orientation. For example, the network entity 205 may request that the UE 210-a reports its current position to the nearest meter or to a specified decimal place in terms of geographic coordinates or elevation, that the UE 210-a reports its current orientation to the nearest degree, the nearest 3 degrees, the nearest 5 degrees, etc. The network entity 205 may transmit information indicative of the requested granularities via a control message (e.g., a DCI message). The network entity 205 may transmit the request for the beam selection report and the requested granularities via a single control message (e.g., a single DCI message) or via separate control messages (e.g., separate DCI messages). The network entity 205 may also transmit, to the UE 210-a, information indicative of a granularity of the current Tx beam to be reported by the network entity 205.

The UE 210-a may transmit the beam selection report to the network entity 205 in accordance with receiving the request from the network entity 205. Additionally, or alternatively, the UE 210-a may transmit the beam selection report without receiving an explicit request from the network entity 205. For example, the UE 210-a may transmit the beam selection report in accordance with a time periodicity (which may be indicated to the UE 210-a from the network entity 205) or in accordance with the UE 210-a moving to a specific location (e.g., a specific location in a grid of locations, which may be indicated to the UE 210-a from the network entity 205).

The UE 210-a may transmit the beam selection report as a control message (e.g., a UCI message). In some examples, the UE 210-a may transmit another beam selection report to the network entity 205 at specified time intervals (e.g., every 5 minutes, every 30 minutes, every 60 minutes, or every X minutes, where X may be indicated to the UE 210-a from the network entity 205). In other words, the UE 210-a may transmit a beam selection report according to a temporal periodicity. In some examples, the UE 210-a may transmit another beam selection report to the network entity 205 as the UE 210-a moves through space (e.g., transmits a beam selection report after moving a meter or X meters relative to where the UE 210-a last transmitted a beam selection report, where X may be indicated to the UE 210-a from the network entity 205). In other words, as the UE 210-a moves, the UE 210-a may transmit a beam selection report according to a spatial periodicity. In some examples, the UE 210-a may transmit another beam selection report to the network entity 205 as the UE 210-a changes orientation (e.g., azimuth, elevation), for example, transmitting a beam selection report for every X degrees of change relative to the last orientation at which the UE 210-a transmitted a beam selection report (where X may be indicated to the UE 210-a from the network entity 205). In other words, the UE 210-a may transmit a beam selection report according to an orientation periodicity. In some examples, the UE 210-a may transmit a beam selection report according to a temporal periodicity, a spatial periodicity, an orientation periodicity, or any combination thereof.

The network entity 205 may store the information associated with the beam selection report (e.g., UE position, UE orientation, Tx beam, Rx beam, timestamp) in a database. The network entity 205 may include information associated with one or more (and potentially many) different beam selection reports and select beam selection parameters to transmit to a UE 210 based on the relevance of the parameters (e.g., a proximity of the UE 210 to a stored or “tagged” position, a similarity of the UE 210 to a stored or “tagged” orientation, or any combination thereof). The network entity 205 may associate the Tx beam and the UE position at the time of the beam selection report with the beam selection report even if the Tx beam and the UE position are not transmitted in the beam selection report (as the network entity 205 may already have that information). The network entity 205 may generate a map or grid using the database. For example, the map or grid may be associated with positions and/or orientations stored in the database, each position and orientation corresponding to (e.g., pairing with) an Rx beam and a Tx beam (e.g., a Tx-Rx beam combination).

The network entity 205 may transmit a beam selection report to the UE 210-a that the UE 210-a (or any other UE 210) had previously transmitted to the network entity 205, the beam selection report including information indicative of a first position and first orientation. For example, the UE 210-a may change position or orientation such that the network entity 205 and UE 210-a select a new Tx-Rx beam combination. The network entity 205 may transmit a previous beam selection report to the UE 210-a if the UE 210-a satisfies a position threshold (e.g., the current position of the UE 210-a is within a threshold distance of the first position), satisfies an orientation threshold (e.g., the current orientation of the UE 210-a is within a threshold quantity of degrees of the first orientation), or any combination thereof. The network entity may transmit, to the UE 210-a, the previous beam selection report (e.g., a previously selected Rx beam index, a quantity of Rx antennas used by the previous reporting UE that reported the Rx beam index, a previous UE azimuth index, and/or a previous UE elevation index) as well as information indicative of the previous Tx beam index and a timestamp.

The UE 210-a may use the information of the beam selection report and the additional information to select a Tx beam search window, an Rx beam search window, and corresponding search window centers (e.g., an Rx beam window center, a Tx beam window center, or both). The Rx beam window center may correspond to the previous Rx beam index indicated by the beam selection report transmitted by the network entity 205. The Tx beam window center may correspond to the previous Tx beam index indicated by the beam selection report transmitted by the network entity 205. A first size of the Tx beam search window and a second size of the Rx beam search window may be based on the proximity of the current position of the UE 210-a to the first position, a similarity between the current orientation of the UE 210-a to the first orientation, a recency of the timestamp, or any combination thereof.

For example, if the current position is relatively closer to the first position, the search windows may be relatively smaller. Alternatively, if the current position is relatively farther from the first position, the search windows may be relatively larger. The size of the Tx beam search window and the size of the Rx beam search window may additionally, or alternatively, be based on the similarity of the current orientation of the UE 210-a to the first orientation. For example, if the current orientation is relatively similar to the first orientation, the search windows may be relatively smaller. Alternatively, if the current orientation is relatively not similar to the first orientation, the search windows may be relatively larger. The size of the Tx beam search window and the size of the Rx beam search window may additionally, or alternatively, be based on the timestamp. For example, if a timestamp of the previous beam selection report is relatively closer to a current time, the search windows may be relatively smaller. Alternatively, if the timestamp is relatively far from a current time, the search windows may be relatively larger.

The UE 210-a may transmit the selected information (e.g., information indicative of the selected Tx beam search window size, the selected Rx beam search window size, the selected Tx beam search window center, and the selected Rx beam search window center) to the network entity 205. The selections may be based on the information received by the network entity 205. In some implementations, the UE 210-a may transmit information indicative of the selections via a UCI message. The network entity 205 and the UE 210-a may perform a beam selection procedure (e.g., a beamforming process) based on the selected Tx beam search window, the Rx beam search window, and the search window centers for the Tx and Rx beams.

In some examples, the network entity 205 may transmit information received via a previous beam selection report from the UE 210-a to the UE 210-b in response to a proximity of UE 210-b to UE 210-a (such as to a current position and/or orientation of the UE 210-a or a “tagged” position and/or orientation of the UE 210-a when the UE 210-a transmitted the previous beam selection report). For example, the UE 210-b may satisfy a threshold (e.g., be located within a distance threshold of the tagged position associated with the beam selection report from the UE 210-a or be oriented similarly to the tagged orientation associated with the beam selection report from UE 210-a). Parameters associated with the beam selection report transmitted by the UE 210-a may be stored in the database (e.g., may be mapped by the network entity 205). The UE 210-b may use parameters associated with the beam selection report originally transmitted to the network entity 205 by the UE 210-a to select beam selection parameters. For example, the beam selection report transmitted by the UE 210-a may include a position (e.g., coordinate) and orientation (e.g., azimuth, elevation) of UE 210-a, and a selected Rx beam at the time of reporting by the UE 210-a. The network entity 205 may add a timestamp and a Tx beam to such information and may transmit the accumulated information to the UE 210-b. The UE 210-b may use this information to select a Tx beam search window, an Rx beam search window, Tx beam search window center, and an Rx beam search window center. The UE 210-b and the network entity 205 may use these selected parameters to perform a beam selection process (which may be equivalently referred to as a beam selection procedure).

In some examples, the network entity 205 may transmit a beam selection report from a UE previously at the tagged position 215 to the UE 210-c in response to a proximity of the UE 210-c to the tagged position 215. For example, the UE 210-c may be satisfy a threshold (e.g., be located within a distance threshold to the tagged position 215 or be oriented similarly to a UE previously at the tagged position 215). Parameters associated with the beam selection report associated with the tagged position 215 may be stored in the database (e.g., may be mapped by the network entity 205). The UE 210-c may use parameters associated with the beam selection report associated with the tagged position 215 to select parameters for a beam selection procedure. For example, the beam selection report associated with the tagged position 215 may include a position (e.g., tagged coordinate information or distance from the network entity 205) and/or an orientation (e.g., a tagged azimuth and/or a tagged elevation) of the UE previously at the tagged position 215, a timestamp, a selected Rx beam, and a Tx beam corresponding to the selected Rx beam. The network entity 205 may transmit this information to the UE 210-c in accordance with the UE 210-c becoming within a threshold distance of the tagged position 215. The UE 210-c may use this information to select a Tx beam search window, an Rx beam search window, Tx beam search window center, and an Rx beam search window center. The UE 210-c and the network entity 205 may use these selected parameters to perform a beam selection procedure.

In some implementations, the selected search windows may be than what the UEs 210 may have otherwise used, which decreases the complexity of the beamforming process. This may result in decreased power consumption and decreased latency compared to other beamforming processes. The process described also allows for more accurate tracking of the dynamics of the UEs 210 (e.g., mobility, rotation).

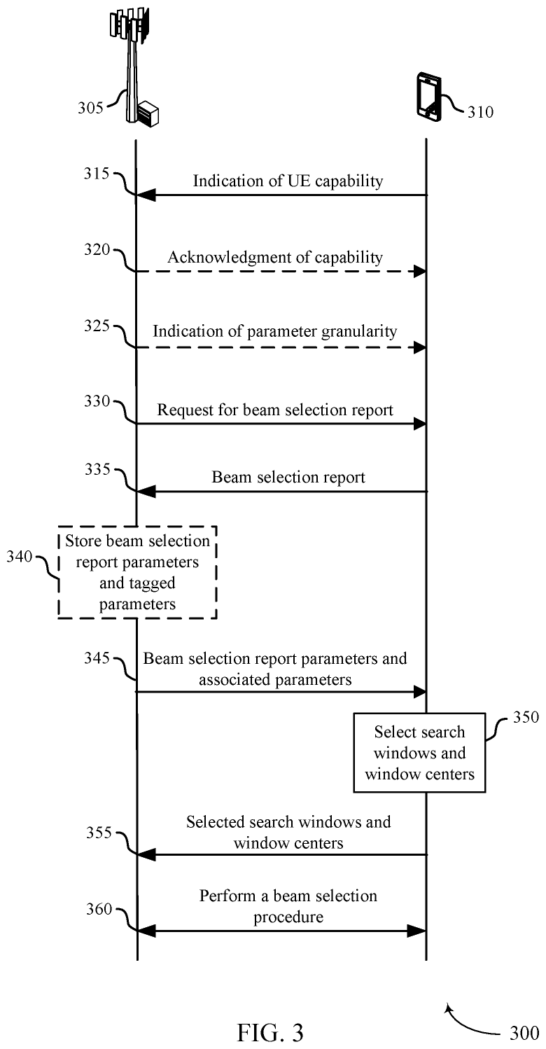

FIG. 3 shows an example of a process flow 300 that supports fast beam selection via UE Rx beam selection reporting in accordance with one or more aspects of the present disclosure. The process flow 300 may implement or be implemented to realize aspects of the wireless communications system 100, the wireless communications system 200, or both. The process flow 300 illustrates communication between a network entity 305 (which may be an example of a network entity 105 or a network entity 205 as illustrated by and described herein with reference to FIGS. 1 and 2, respectively) and a UE 310 (which may be an example of a UE 115 or a UE 210 as illustrated by and described herein with reference to FIGS. 1 and 2, respectively. The network entity 305 and UE 310 may communicate via one or more communication links, such as a communication link 220 or a communication link 125 as illustrated by and described herein with reference to FIGS. 1 and 2, respectively.

In the following description of the process flow 300, the operations may be performed (such as reported or provided) in a different order than the order shown, or the operations performed by the example devices may be performed in different orders or at different times. For example, specific operations also may be left out of the process flow 300, or other operations may be added to the process flow 300. Further, although some operations or signaling may be shown to occur at different times for discussion purposes, these operations may actually occur at the same time.

At 315, the UE 310 may transmit, to the network entity 305 (e.g., gNB), signaling indicating a capability of the UE to transmit a beam selection report, a capability to receive parameters associated with a beam selection report, or both. In other words, the UE may transmit an indication of its capability to support the beam selection process (e.g., beamforming process) as described herein. The UE 310 may signal the capability when first connecting to the network entity 305 or at another time. The UE 310 may transmit the capability multiple times. In other words, prior to the beam selection process, the UE 310 may report a capability of the UE 310 to indicate whether the UE 310 supports a fast beam selection mode.

At 320, the network entity 305 may transmit, to the UE 310, an acknowledgment of the capability signaled by the UE 310 at 315. The acknowledgment may be transmitted as a DCI message.

At 325, the network entity 305 may transmit, to the UE 310, an indication of a granularity of parameters in the beam selection report. For example, the network entity 305 may specify the granularity of the Tx beam index, the Rx beam index (including or otherwise indicating or associated with a quantity of Rx antennas), a UE 310 position (e.g., coordinates), a UE 310 orientation (e.g., an azimuth index and/or an elevation index), or any combination thereof. For example, the network entity may request that a beam selection report containing the UE 310 position includes coordinates to the nearest meter, etc. The indication of parameter granularity may be transmitted as a DCI. The indication of parameter granularity may be transmitted in the same DCI as the acknowledgment of UE 310 capability or may be transmitted in a separate DCI.

At 330, the network entity 305 may transmit, to the UE 310, a request for a beam selection report. Such a request may be understood as a beam selection report request. The network entity 305 may request a beam selection report based on a time periodicity or a physical location periodicity. The request may be communicated via a DCI message. The beam selection report requested for transmission by the UE 310 may include a selected Rx beam index (which may include a quantity of Rx antennas), a UE azimuth index, and a UE elevation index.

At 335, the UE 310 may transmit, to the network entity 305, the beam selection report. The beam selection report may convey current information about the UE 310. The UE 310 may transmit the beam selection report according to a predefined periodicity (e.g., a time periodicity and/or a physical location periodicity). The beam selection report may include a selected Rx beam index (which may include a quantity of Rx antennas), a UE azimuth index, or a UE elevation index (which may be understood as a position or a component of an orientation, or both, of the UE 310), or any combination thereof. The UE 310 may transmit the beam selection report in accordance with the requested granularities.

At 340, the network entity 305 may “tag” information included in the beam selection report as well as additional information associated with the beam selection report (e.g., information associated with the UE 310 at the time that the beam selection report was communicated). For example, the network entity 305 may tag a selected Tx beam (e.g., which may already be known by the network entity 305), the selected Rx beam, the UE 310 azimuth, the UE 310 elevation, the UE 310 position, and a timestamp according to the granularity and store this information in a database. The network entity 305 may generate a map or grid based on the information stored in the database. For example, the network entity 305 may progressively build a database with UE position, orientation (azimuth, elevation), and selected Rx beam such that it can advise other UEs in a same or similar orientation and position on a recommended beam and assist the UE in narrowing an Rx/Tx beam search. In some implementations, different UEs may report different beam types. In such implementations, the network entity 305 may support an algorithm, mapping table, or model (or any other means) to correlate different UE types' beams (i.e., different types of UEs may report different beams, different types of beams, or may report beams in different manners, such as by referencing different types of reference signals or different Rx antenna configurations). In some examples, the network entity 305 may include such an algorithm, mapping table, or model in the database of the network entity 305.

At 345, the network entity 305 may transmit, to the UE 310, beam selection report parameters, tagged parameters, or any combination thereof in accordance with a proximity of the UE 310 to a tagged position. For example, the network entity 305 may transmit a beam selection report indicating a selected Tx beam index, a selected Rx beam index, a quantity of Rx antennas, a UE azimuth, a UE elevation, a UE position, and a timestamp. The contents or parameters of the beam selection report may be gathered by the network entity 305 via a previous beam selection report received from another UE or from the UE 310 (which may be the case in scenarios in which the UE 310 returns to an earlier position at which the UE 310 previously transmitted a beam selection report). The network entity 305 may transmit the parameters to the UE 310 in response to the UE 310 coming within a threshold distance of the tagged position. In other words, the UE 310 comes within a close enough range. The map generated from the database may allow the network entity 305 to transmit the most relevant tagged information (e.g., parameters associated with a tagged location closest to UE 310 and/or with a tagged orientation most similar to that of UE 310) to the UE 310.

Between 335 and 345, the UE 310 may change locations. Alternatively, the UE 310 described at 330 through 335 may be a different UE than the UE 310 described at 345 through 360. If different UEs 310, the network entity 305 may transmit the parameters at 345 based on a first UE 310 described at 345 being close to a position of (e.g., proximate to) a second UE 310 described at 335 when the second UE 310 transmitted a previous beam selection report.

At 350, the UE 310 may select search windows for Rx and Tx beams as well as search window centers for the Rx and Tx beams. The UE 310 may determine whether to use the information transmitted by the network entity 305 to select the search windows as well as search window centers. The determination may be based on whether the orientation (e.g., azimuth and/or elevation) of the UE 310 is within a threshold range of the orientation transmitted by the network entity 305. In other words, the UE 310 may determine to use the parameters transmitted at 345 if the UE 310 orientation at 350 is close to the orientation received by the network entity 305 at 335. A size of the Rx search window and a size of the Tx search window may be associated with the relevance of the report transmitted by the network entity 305 at 345. For example, if the orientation of the UE 310 is close to the orientation transmitted by the network entity 305 at 345, the search windows may be relatively smaller than if the orientation of the UE 310 is not close to the orientation transmitted by the network entity 305 at 345. In other words, a high relevance (e.g., a high confidence) may result in small search windows. The Rx search window and the Tx search window may have different sizes.

In some examples, the determination of the UE 310 of whether to use the information transmitted by the network entity 305 to select the search windows as well as search window centers may be based in part on other information that the UE 310 has access to (e.g., information not received at 345). In some examples, the UE 310 may determine to use the information transmitted by the network entity 305 while also using other information (e.g., information not received at 345) such that the information transmitted by the network entity 305 is given less weight in selecting the search windows and search window centers. The more weight the information transmitted by the network entity 305 is given, the closer the Rx and Tx search window centers may be to the transmitted Rx and Tx beam indices respectively.

At 355, the UE 310 may transmit, to the network entity 305, the selected Tx and Rx beam search windows and Tx and Rx search window centers. The search window centers may be based on (e.g., correspond to) the Tx and Rx beam indices received from the network entity 305 at 345. The information may be conveyed via a UCI.

At 360, the UE 310 and network entity 305 may perform a beam selection procedure. The UE 310 and network entity 305 may perform the beam selection procedure using the Tx and Rx beam search windows and the Tx and Rx search window centers selected by the UE 310. By using the beamforming process as described herein, the selected search windows may be smaller windows than the UE 310 may have otherwise used, which decreases the complexity of the beam selection process and results in decreased power consumption and decreased latency compared to other beam selection processes. The process described also allows for more accurate tracking of the dynamics of the UE 310 (e.g., mobility, rotation).

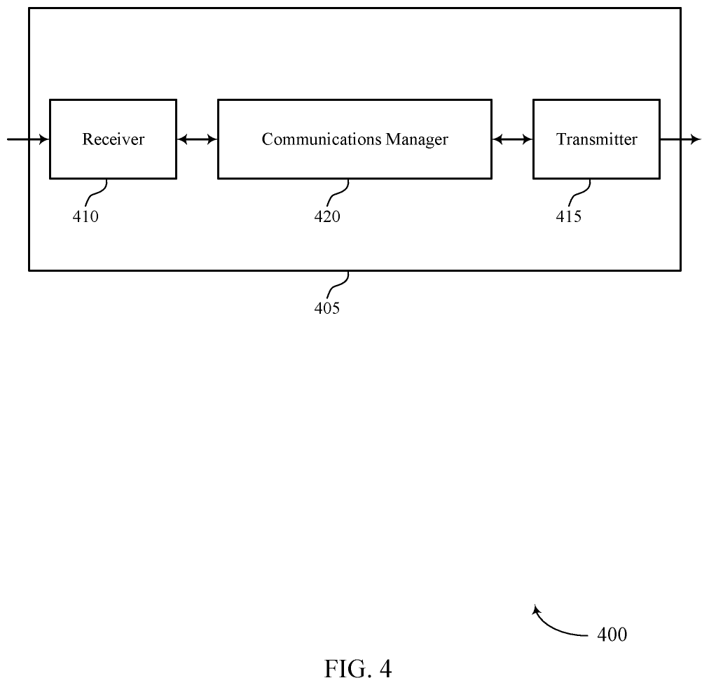

FIG. 4 shows a block diagram 400 of a device 405 that supports fast beam selection via UE Rx beam selection reporting in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, and the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to fast beam selection via UE Rx beam selection reporting). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to fast beam selection via UE Rx beam selection reporting). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of fast beam selection via UE Rx beam selection reporting as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (not shown). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication in accordance with examples as disclosed herein. For example, the communications manager 420 is capable of, configured to, or operable to support a means for transmitting an indication of a capability of the UE to communicate one or more beam selection reports, each beam selection report including information indicative of a current Rx beam of the UE, a current position of the UE, and a current orientation of the UE. The communications manager 420 is capable of, configured to, or operable to support a means for receiving, based on the capability of the UE, a request for a beam selection report from the UE. The communications manager 420 is capable of, configured to, or operable to support a means for transmitting the beam selection report based on the request, the beam selection report including information indicative of a first Rx beam of the UE, a first position of the UE, and a first orientation of the UE.

Additionally, or alternatively, the communications manager 420 may support wireless communication in accordance with examples as disclosed herein. For example, the communications manager 420 is capable of, configured to, or operable to support a means for receiving a first beam selection report based on a proximity of the UE to a first position, the first beam selection report including information indicative of at least a first Tx beam of a network entity and a first Rx beam corresponding to the first Tx beam. The communications manager 420 is capable of, configured to, or operable to support a means for transmitting an indication of a first set of parameters associated with beam selection at the UE, the first set of parameters being based on the first Tx beam and the first Rx beam. The communications manager 420 is capable of, configured to, or operable to support a means for performing a beam selection procedure with the network entity based on the first set of parameters.

By including or configuring the communications manager 420 in accordance with examples as described herein, the device 405 (e.g., at least one processor controlling or otherwise coupled with the receiver 410, the transmitter 415, the communications manager 420, or any combination thereof) may support techniques for faster beam selection processes than other methods. For example, the selected search window may be a smaller window than the device 405 may have otherwise used, which decreases the complexity of the beam selection process and results in decreased power consumption and decreased latency compared to other beam selection processes. The process described may also allow for more accurate tracking of the dynamics of the device 405 (e.g., mobility, rotation).

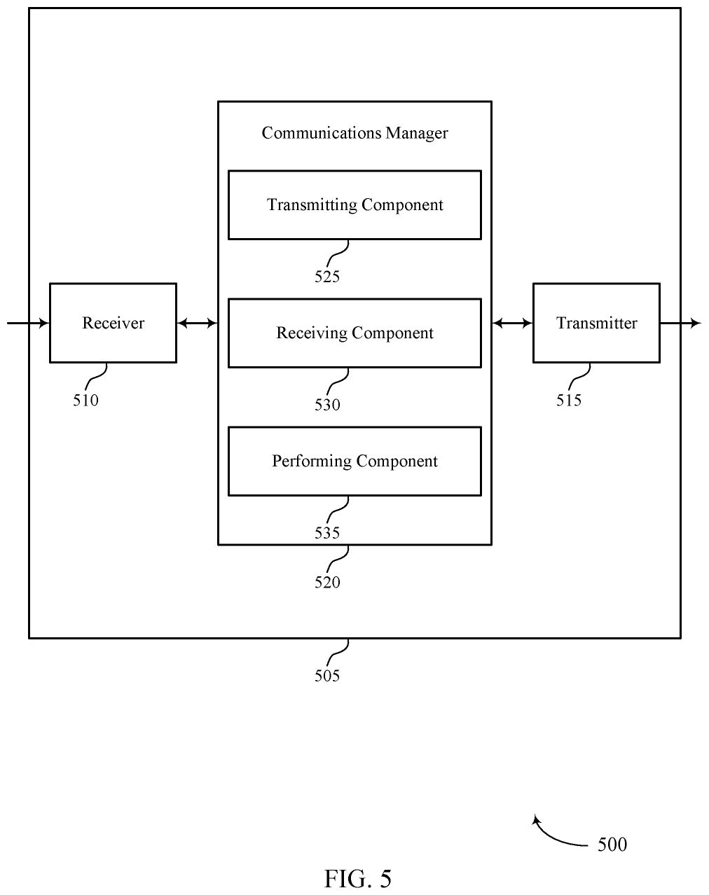

FIG. 5 shows a block diagram 500 of a device 505 that supports fast beam selection via UE Rx beam selection reporting in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to fast beam selection via UE Rx beam selection reporting). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to fast beam selection via UE Rx beam selection reporting). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of fast beam selection via UE Rx beam selection reporting as described herein. For example, the communications manager 520 may include a transmitting component 525, a receiving component 530, a performing component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. The transmitting component 525 is capable of, configured to, or operable to support a means for transmitting an indication of a capability of the UE to communicate one or more beam selection reports, each beam selection report including information indicative of a current Rx beam of the UE, a current position of the UE, and a current orientation of the UE. The receiving component 530 is capable of, configured to, or operable to support a means for receiving, based on the capability of the UE, a request for a beam selection report from the UE. The transmitting component 525 is capable of, configured to, or operable to support a means for transmitting the beam selection report based on the request, the beam selection report including information indicative of a first Rx beam of the UE, a first position of the UE, and a first orientation of the UE.

Additionally, or alternatively, the communications manager 520 may support wireless communication in accordance with examples as disclosed herein. The receiving component 530 is capable of, configured to, or operable to support a means for receiving a first beam selection report based on a proximity of the UE to a first position, the first beam selection report including information indicative of at least a first Tx beam of a network entity and a first Rx beam corresponding to the first Tx beam. The transmitting component 525 is capable of, configured to, or operable to support a means for transmitting an indication of a first set of parameters associated with beam selection at the UE, the first set of parameters being based on the first Tx beam and the first Rx beam. The performing component 535 is capable of, configured to, or operable to support a means for performing a beam selection procedure with the network entity based on the first set of parameters.

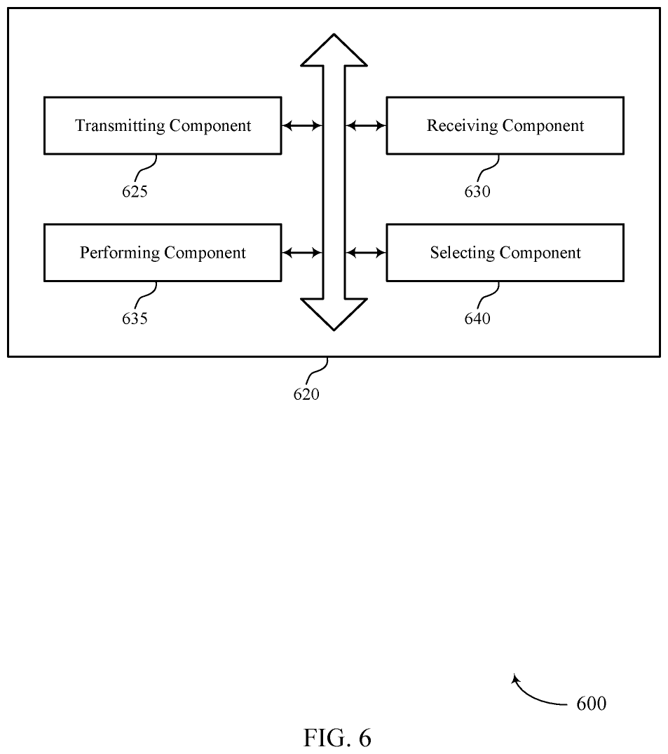

FIG. 6 shows a block diagram 600 of a communications manager 620 that supports fast beam selection via UE Rx beam selection reporting in accordance with one or more aspects of the present disclosure. The communications manager 620 may be an example of aspects of a communications manager 420, a communications manager 520, or both, as described herein. The communications manager 620, or various components thereof, may be an example of means for performing various aspects of fast beam selection via UE Rx beam selection reporting as described herein. For example, the communications manager 620 may include a transmitting component 625, a receiving component 630, a performing component 635, a selecting component 640, or any combination thereof. Each of these components, or components or subcomponents thereof (e.g., one or more processors, one or more memories), may communicate, directly or indirectly, with one another (e.g., via one or more buses).

The communications manager 620 may support wireless communication in accordance with examples as disclosed herein. The transmitting component 625 is capable of, configured to, or operable to support a means for transmitting an indication of a capability of the UE to communicate one or more beam selection reports, each beam selection report including information indicative of a current Rx beam of the UE, a current position of the UE, and a current orientation of the UE. The receiving component 630 is capable of, configured to, or operable to support a means for receiving, based on the capability of the UE, a request for a beam selection report from the UE. In some examples, the transmitting component 625 is capable of, configured to, or operable to support a means for transmitting the beam selection report based on the request, the beam selection report including information indicative of a first Rx beam of the UE, a first position of the UE, and a first orientation of the UE.

In some examples, the receiving component 630 is capable of, configured to, or operable to support a means for receiving, based on the capability of the UE, a control message including information indicative of requested granularities for Rx beams reported by the UE, positions reported by the UE, and orientations reported by the UE, where each of the first Rx beam of the UE, the first position of the UE, and the first orientation of the UE are in accordance with the requested granularities.

In some examples, the control message further includes information indicative of a granularity of a transmit beam, of a network entity, to be reported by the network entity.

In some examples, the beam selection report is transmitted at a first time, and the transmitting component 625 is capable of, configured to, or operable to support a means for transmitting a second beam selection report at a second time based on a time periodicity associated with the one or more beam selection reports, the second beam selection report including information indicative of a second Rx beam of the UE at the second time, a second position of the UE at the second time, and a second orientation of the UE at the second time.

In some examples, the beam selection report is transmitted in accordance with one or both of the first position or the first orientation being within a threshold distance or orientation of a first tagged position or a first tagged orientation, and the transmitting component 625 is capable of, configured to, or operable to support a means for transmitting a second beam selection report based on one or both of a second position of the UE or a second orientation of the UE being within the threshold distance or orientation of a second tagged position or a second tagged orientation, respectively.

In some examples, the receiving component 630 is capable of, configured to, or operable to support a means for receiving a second beam selection report based on the current position of the UE becoming within a threshold distance of a second position, the second beam selection report including information indicative of at least a Tx beam of a network entity and an Rx beam corresponding to the Tx beam. In some examples, the transmitting component 625 is capable of, configured to, or operable to support a means for transmitting an indication of a first set of parameters associated with beam selection at the UE, the first set of parameters being based on the Tx beam and the Rx beam. In some examples, the performing component 635 is capable of, configured to, or operable to support a means for performing a beam selection procedure with the network entity based on the first set of parameters.

In some examples, the second beam selection report further includes information indicative of the second position, a second orientation, and a timestamp corresponding to a third beam selection report via which the Rx beam, the second position, and the second orientation is reported.

In some examples, the selecting component 640 is capable of, configured to, or operable to support a means for selecting the first set of parameters based on the Tx beam, the Rx beam, the second position, the second orientation, and the timestamp, where the first set of parameters include a Tx beam search window, an Rx beam search window, a Tx beam window center, and an Rx beam window center.

In some examples, the request is received via a DCI message and the beam selection report is transmitted via a UCI message.

In some examples, information indicative of the first position of the UE and information indicative of the first orientation of the UE includes coordinate information, elevation information, azimuth information, or any combination thereof. In some examples, information indicative of the first Rx beam may include an indication of a quantity of Rx antennas.

Additionally, or alternatively, the communications manager 620 may support wireless communication in accordance with examples as disclosed herein. In some examples, the receiving component 630 is capable of, configured to, or operable to support a means for receiving a first beam selection report based on a proximity of the UE to a first position, the first beam selection report including information indicative of at least a first Tx beam of a network entity and a first Rx beam corresponding to the first Tx beam. In some examples, the transmitting component 625 is capable of, configured to, or operable to support a means for transmitting an indication of a first set of parameters associated with beam selection at the UE, the first set of parameters being based on the first Tx beam and the first Rx beam. The performing component 635 is capable of, configured to, or operable to support a means for performing a beam selection procedure with the network entity based on the first set of parameters.

In some examples, the first beam selection report further includes information indicative of the first position, a first orientation, and a first timestamp corresponding to a second beam selection report via which the first Rx beam, the first position, and the first orientation is reported.

In some examples, the selecting component 640 is capable of, configured to, or operable to support a means for selecting the first set of parameters based on the first Tx beam, the first Rx beam, the first position, the first orientation, and the first timestamp, where the first set of parameters include a first Tx beam search window, a first Rx beam search window, a first Tx beam window center, and a first Rx beam window center.

In some examples, respective sizes of the first Tx beam search window and the first Rx beam search window are associated with the proximity of a current position of the UE to the first position, a similarity of a current orientation of the UE to the first orientation, and a time duration between the first timestamp and a time at which the first beam selection report is received by the UE.

In some examples, the first Tx beam window center is the first Tx beam and the first Rx beam window center is the first Rx beam.

In some examples, the information indicative of the first position and information indicative of the first orientation includes coordinate information, elevation information, azimuth information, or any combination thereof. In some examples, information indicative of the first Rx beam includes an indication of a quantity of Rx antennas.

In some examples, the receiving component 630 is capable of, configured to, or operable to support a means for receiving a second beam selection report based on the UE becoming within a threshold distance to a second position, the second beam selection report including information indicative of at least a second Tx beam of the network entity and a second Rx beam corresponding to the second Tx beam. In some examples, the transmitting component 625 is capable of, configured to, or operable to support a means for transmitting an indication of a second set of parameters associated with the beam selection at the UE, the second set of parameters being based on the second Tx beam and the second Rx beam. In some examples, the performing component 635 is capable of, configured to, or operable to support a means for performing a second beam selection procedure with the network entity based on the second set of parameters associated with the beam selection at the UE.

In some examples, the transmitting component 625 is capable of, configured to, or operable to support a means for transmitting an indication of a capability of the UE to communicate one or more beam selection reports, each beam selection report including information indicative of a current Rx beam of the UE, a current position of the UE, and a current orientation of the UE. In some examples, the receiving component 630 is capable of, configured to, or operable to support a means for receiving, based on the capability of the UE, a request for a beam selection report from the UE. In some examples, the transmitting component 625 is capable of, configured to, or operable to support a means for transmitting the beam selection report based on the request, the beam selection report including information indicative of a second Rx beam of the UE, a second position of the UE, and a second orientation of the UE.

In some examples, the receiving component 630 is capable of, configured to, or operable to support a means for receiving, based on the capability of the UE, a control message including information indicative of requested granularities for Rx beams reported by the UE, positions reported by the UE, and orientations reported by the UE, where each of the second Rx beam of the UE, the second position of the UE, and the second orientation of the UE are in accordance with the requested granularities.

In some examples, the UE receives the first beam selection report based on a current position of the UE becoming within a threshold distance to the first position.

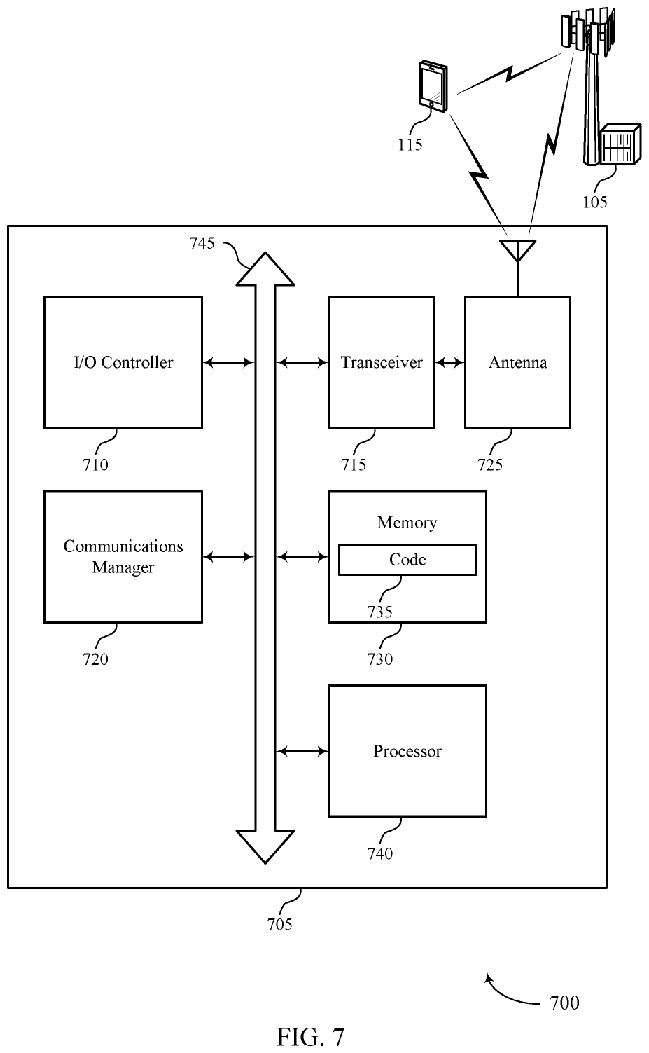

FIG. 7 shows a diagram of a system 700 including a device 705 that supports fast beam selection via UE Rx beam selection reporting in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable code 735 including instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may contain, among other things, a basic I/O system (BIOS) which may control basic hardware or software operation such as the interaction with peripheral components or devices.

The at least one processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting fast beam selection via UE Rx beam selection reporting). For example, the device 705 or a component of the device 705 may include at least one processor 740 and at least one memory 730 coupled with or to the at least one processor 740, the at least one processor 740 and at least one memory 730 configured to perform various functions described herein. In some examples, the at least one processor 740 may include multiple processors and the at least one memory 730 may include multiple memories. One or more of the multiple processors may be coupled with one or more of the multiple memories, which may, individually or collectively, be configured to perform various functions herein.

In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. As such, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code stored in the at least one memory 730 or otherwise, to perform one or more of the functions described herein.

The communications manager 720 may support wireless communication in accordance with examples as disclosed herein. For example, the communications manager 720 is capable of, configured to, or operable to support a means for transmitting an indication of a capability of the UE to communicate one or more beam selection reports, each beam selection report including information indicative of a current Rx beam of the UE, a current position of the UE, and a current orientation of the UE. The communications manager 720 is capable of, configured to, or operable to support a means for receiving, based on the capability of the UE, a request for a beam selection report from the UE. The communications manager 720 is capable of, configured to, or operable to support a means for transmitting the beam selection report based on the request, the beam selection report including information indicative of a first Rx beam of the UE, a first position of the UE, and a first orientation of the UE.

Additionally, or alternatively, the communications manager 720 may support wireless communication in accordance with examples as disclosed herein. For example, the communications manager 720 is capable of, configured to, or operable to support a means for receiving a first beam selection report based on a proximity of the UE to a first position, the first beam selection report including information indicative of at least a first Tx beam of a network entity and a first Rx beam corresponding to the first Tx beam. The communications manager 720 is capable of, configured to, or operable to support a means for transmitting an indication of a first set of parameters associated with beam selection at the UE, the first set of parameters being based on the first Tx beam and the first Rx beam. The communications manager 720 is capable of, configured to, or operable to support a means for performing a beam selection procedure with the network entity based on the first set of parameters.

By including or configuring the communications manager 720 in accordance with examples as described herein, the device 705 may support techniques for faster beam selection. The selected search window may be a smaller window than the device 705 may have otherwise used in other methods, which decreases the complexity of the beam selection process and results in decreased power consumption and decreased latency compared to other beam selection processes. The process described also allows for more accurate tracking of the dynamics of the device 705 (e.g., mobility, rotation). The decreased latency and decreased power consumption may improve user experience.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described herein with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of fast beam selection via UE Rx beam selection reporting as described herein, or the at least one processor 740 and the at least one memory 730 may be otherwise configured to, individually or collectively, perform or support such operations.

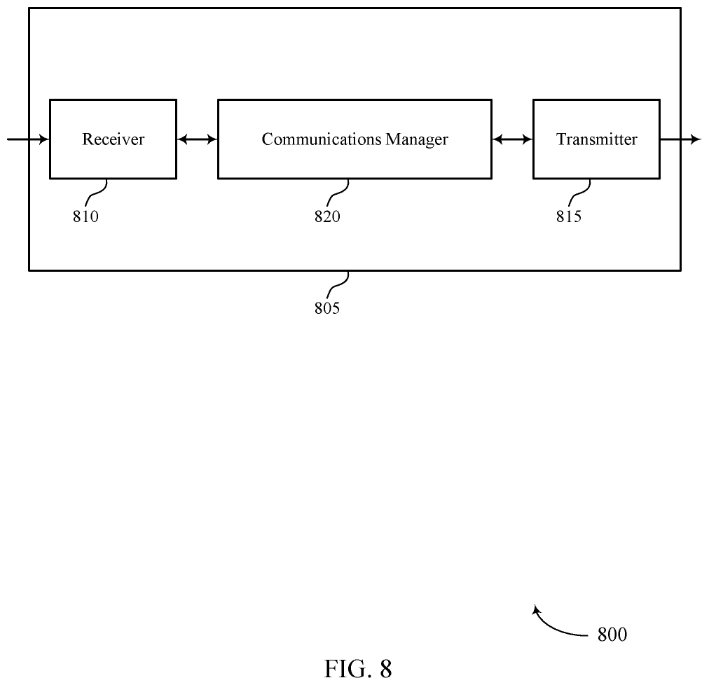

FIG. 8 shows a block diagram 800 of a device 805 that supports fast beam selection via UE Rx beam selection reporting in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of fast beam selection via UE Rx beam selection reporting as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (not shown). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication in accordance with examples as disclosed herein. For example, the communications manager 820 is capable of, configured to, or operable to support a means for receiving an indication of a capability of a UE to communicate one or more beam selection reports, each beam selection report including information indicative of a current Rx beam of the UE, a current position of the UE, and a current orientation of the UE. The communications manager 820 is capable of, configured to, or operable to support a means for transmitting, based on the capability of the UE, a request for a beam selection report from the UE. The communications manager 820 is capable of, configured to, or operable to support a means for receiving, based on the request, the beam selection report including information indicative of a first Rx beam of the UE, a first position of the UE, and a first orientation of the UE.

By including or configuring the communications manager 820 in accordance with examples as described herein, the device 805 (e.g., at least one processor controlling or otherwise coupled with the receiver 810, the transmitter 815, the communications manager 820, or any combination thereof) may support techniques for faster beam selection processes compared to other methods. The selected search window may be a smaller window than the device 805 may have otherwise used, which decreases the complexity of the beam selection process and results in decreased power consumption and decreased latency compared to other beam selection processes.

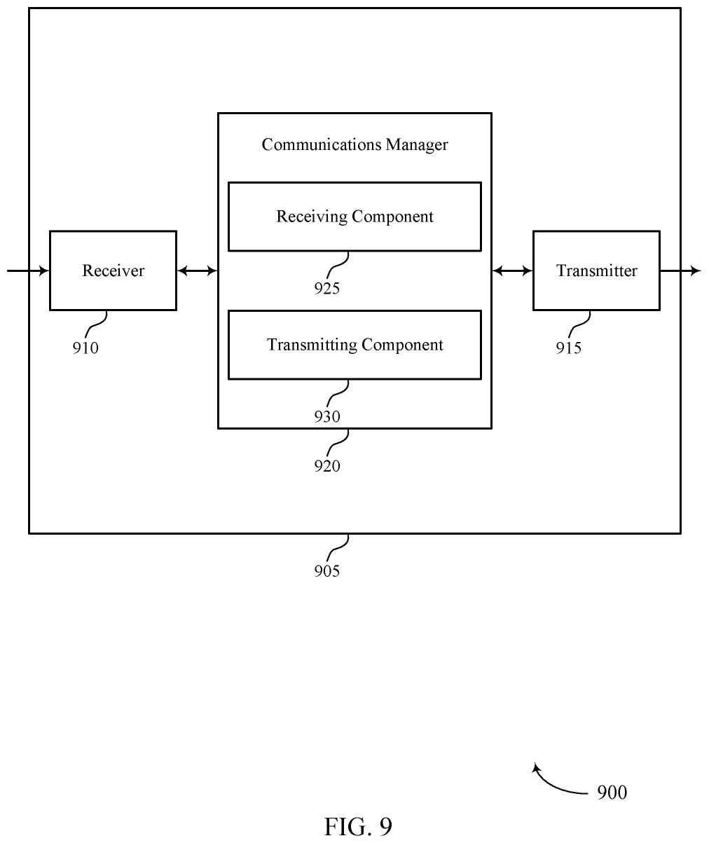

FIG. 9 shows a block diagram 900 of a device 905 that supports fast beam selection via UE Rx beam selection reporting in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of fast beam selection via UE Rx beam selection reporting as described herein. For example, the communications manager 920 may include a receiving component 925 a transmitting component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. The receiving component 925 is capable of, configured to, or operable to support a means for receiving an indication of a capability of a UE to communicate one or more beam selection reports, each beam selection report including information indicative of a current Rx beam of the UE, a current position of the UE, and a current orientation of the UE. The transmitting component 930 is capable of, configured to, or operable to support a means for transmitting, based on the capability of the UE, a request for a beam selection report from the UE. The receiving component 925 is capable of, configured to, or operable to support a means for receiving, based on the request, the beam selection report including information indicative of a first Rx beam of the UE, a first position of the UE, and a first orientation of the UE.

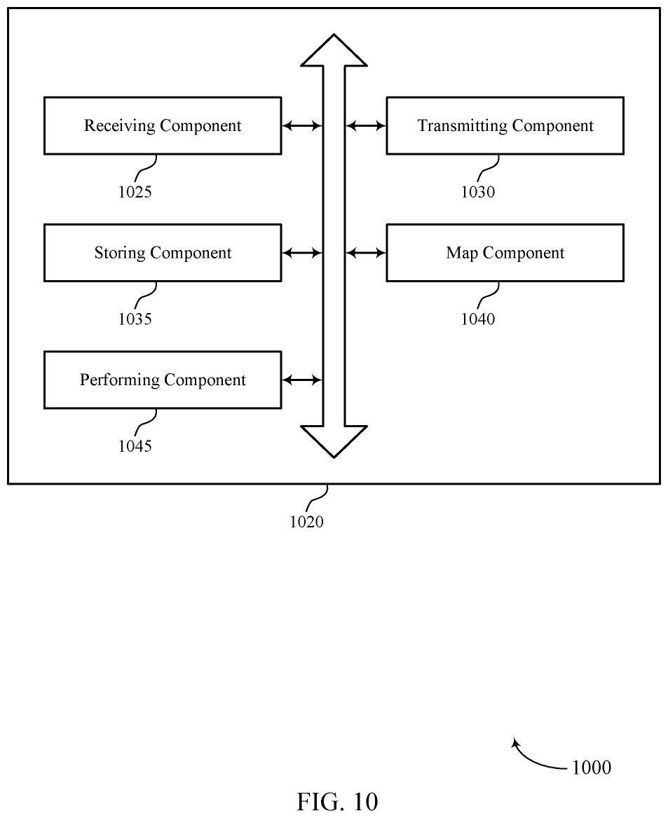

FIG. 10 shows a block diagram 1000 of a communications manager 1020 that supports fast beam selection via UE Rx beam selection reporting in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of fast beam selection via UE Rx beam selection reporting as described herein. For example, the communications manager 1020 may include a receiving component 1025, a transmitting component 1030, a storing component 1035, a map component 1040, a performing component 1045, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communication in accordance with examples as disclosed herein. The receiving component 1025 is capable of, configured to, or operable to support a means for receiving an indication of a capability of a UE to communicate one or more beam selection reports, each beam selection report including information indicative of a current Rx beam of the UE, a current position of the UE, and a current orientation of the UE. The transmitting component 1030 is capable of, configured to, or operable to support a means for transmitting, based on the capability of the UE, a request for a beam selection report from the UE. In some examples, the receiving component 1025 is capable of, configured to, or operable to support a means for receiving, based on the request, the beam selection report including information indicative of a first Rx beam of the UE, a first position of the UE, and a first orientation of the UE.

In some examples, the storing component 1035 is capable of, configured to, or operable to support a means for storing information associated with the beam selection report in a database of the network entity, where the network entity associates, via the database, the first Rx beam of the UE and a first Tx beam of the network entity used to communicate with the UE with the first position of the UE, the first orientation of the UE, and a first timestamp at which the beam selection report is received.

In some examples, the transmitting component 1030 is capable of, configured to, or operable to support a means for transmitting, to a second UE, a second beam selection report based on a second position of the second UE becoming within a threshold distance of the first position, the second beam selection report including information indicative of at least the first Tx beam and the first Rx beam. In some examples, the receiving component 1025 is capable of, configured to, or operable to support a means for receiving an indication of a first set of parameters associated with beam selection at the second UE, the first set of parameters being based on the first Tx beam and the first Rx beam. In some examples, the performing component 1045 is capable of, configured to, or operable to support a means for performing a beam selection procedure with the second UE based on the first set of parameters.

In some examples, the second beam selection report further includes information indicative of the first position, the first orientation, and the first timestamp.

In some examples, the first set of parameters include a first Tx beam search window, a first Rx beam search window, a first Tx beam window center, and a first Rx beam window center.

In some examples, respective sizes of the first Tx beam search window and the first Rx beam search window are associated with a proximity of the second position of the second UE to the first position, a similarity of a second orientation of the second UE to the first orientation, and a time duration between the first timestamp and a time at which the second beam selection report is received by the second UE.

In some examples, the first Tx beam window center is the first Tx beam and the first Rx beam window center is the first Rx beam.

In some examples, the transmitting component 1030 is capable of, configured to, or operable to support a means for transmitting, to the UE and based on the capability of the UE, a control message including information indicative of requested granularities for receive beams reported by the UE, positions reported by the UE, and orientations reported by the UE, where each of the first Rx beam of the UE, the first position of the UE, and the first orientation of the UE are in accordance with the requested granularities.

In some examples, the control message further includes information indicative of a granularity of a Tx beam, of the network entity, to be reported by the network entity.

In some examples, the beam selection report is received at a first time, and the receiving component 1025 is capable of, configured to, or operable to support a means for receiving a second beam selection report at a second time based on a time periodicity associated with the one or more beam selection reports, the second beam selection report including information indicative of a second Rx beam of the UE at the second time, a second position of the UE at the second time, and a second orientation of the UE at the second time.

In some examples, the beam selection report is received in accordance with one or both of the first position or the first orientation being within a threshold distance or orientation of a first tagged position or a first tagged orientation, and the receiving component 1025 is capable of, configured to, or operable to support a means for receiving a second beam selection report based on one or both of a second position of the UE or a second orientation of the UE being within the threshold distance or orientation of a second tagged position or a second tagged orientation, respectively.

In some examples, the receiving component 1025 is capable of, configured to, or operable to support a means for receiving a set of multiple beam selection reports from a set of multiple UEs including the UE, each of the set of multiple beam selection reports including information indicative of a respective current Rx beam, a respective current position, and a respective current orientation of each respective UE of the set of multiple UEs. In some examples, the map component 1040 is capable of, configured to, or operable to support a means for generating a map associated with a set of multiple positions and a set of multiple orientations in accordance with the set of multiple beam selection reports, where the map associates a position and orientation pair to a UE Rx beam and a network entity Tx beam. In some examples, the transmitting component 1030 is capable of, configured to, or operable to support a means for transmitting one or more beam selection reports to one or more UEs of the set of multiple UEs, respectively, in accordance with the one or more UEs moving to one or more positions of the set of multiple positions, respectively.

In some examples, the request is transmitted via a DCI message and the beam selection report is received via a UCI message.

In some examples, information indicative of the first position of the UE and information indicative of the first orientation of the UE includes coordinate information, elevation information, azimuth information, or any combination thereof. In some examples, information indicative of the first Rx beam may include an indication of a quantity of Rx antennas.

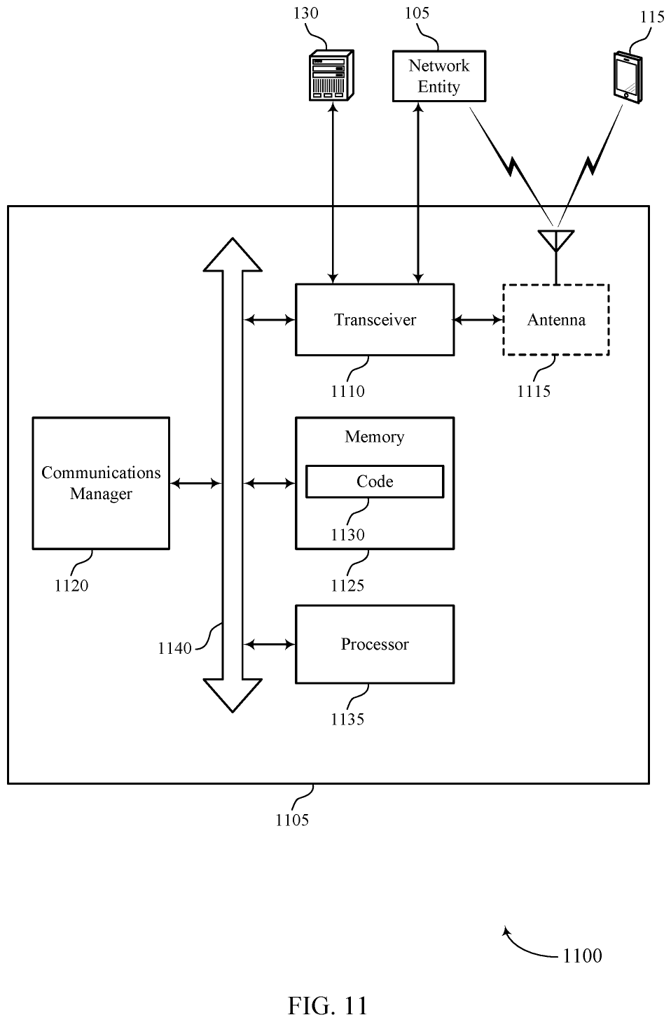

FIG. 11 shows a diagram of a system 1100 including a device 1105 that supports fast beam selection via UE Rx beam selection reporting in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or any combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., a communication link 125, a backhaul communication link 120, a midhaul communication link 162, a fronthaul communication link 168).

The at least one memory 1125 may include RAM, ROM, or any combination thereof. The at least one memory 1125 may store computer-readable, computer-executable code 1130 including instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may contain, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting fast beam selection via UE Rx beam selection reporting). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125). In some examples, the at least one processor 1135 may include multiple processors and the at least one memory 1125 may include multiple memories. One or more of the multiple processors may be coupled with one or more of the multiple memories, which may, individually or collectively, be configured to perform various functions herein.

In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. As such, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communication in accordance with examples as disclosed herein. For example, the communications manager 1120 is capable of, configured to, or operable to support a means for receiving an indication of a capability of a UE to communicate one or more beam selection reports, each beam selection report including information indicative of a current Rx beam of the UE, a current position of the UE, and a current orientation of the UE. The communications manager 1120 is capable of, configured to, or operable to support a means for transmitting, based on the capability of the UE, a request for a beam selection report from the UE. The communications manager 1120 is capable of, configured to, or operable to support a means for receiving, based on the request, the beam selection report including information indicative of a first Rx beam of the UE, a first position of the UE, and a first orientation of the UE.

By including or configuring the communications manager 1120 in accordance with examples as described herein, the device 1105 may support techniques for faster beam selection processes compared to other methods. The beam selection process described herein decreases the complexity of the beam selection process and results in decreased power consumption and decreased latency of the system compared to other beam selection processes. The device 1105 may have improved coordination with other devices in a communications system.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described herein with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of fast beam selection via UE Rx beam selection reporting as described herein, or the at least one processor 1135 and the at least one memory 1125 may be otherwise configured to, individually or collectively, perform or support such operations.

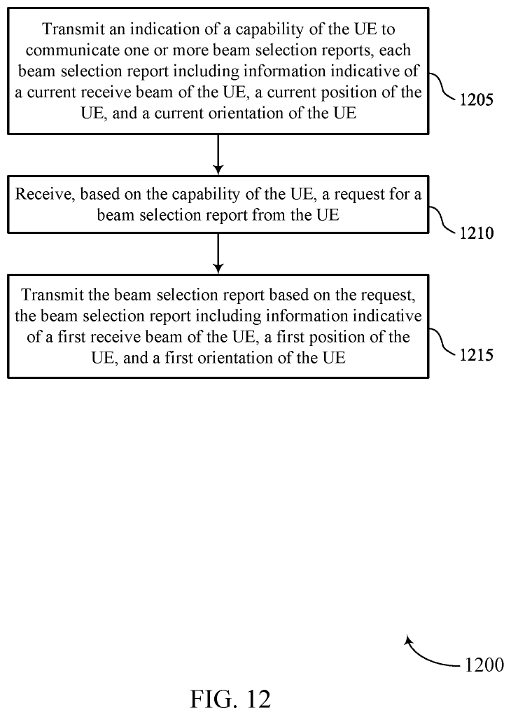

FIG. 12 shows a flowchart illustrating a method 1200 that supports fast beam selection via UE Rx beam selection reporting in accordance with aspects of the present disclosure. The operations of the method 1200 may be implemented by a UE or its components as described herein. For example, the operations of the method 1200 may be performed by a UE 115 as described herein with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include transmitting an indication of a capability of the UE to communicate one or more beam selection reports, each beam selection report including information indicative of a current receive beam of the UE, a current position of the UE, and a current orientation of the UE. The operations of block 1205 may be performed in accordance with examples as disclosed herein. In some examples, aspects of the operations of 1205 may be performed by a transmitting component 625 as described herein with reference to FIG. 6.

At 1210, the method may include receiving, based on the capability of the UE, a request for a beam selection report from the UE. The operations of block 1210 may be performed in accordance with examples as disclosed herein. In some examples, aspects of the operations of 1210 may be performed by a receiving component 630 as described herein with reference to FIG. 6.

At 1215, the method may include transmitting the beam selection report based on the request, the beam selection report including information indicative of a first receive beam of the UE, a first position of the UE, and a first orientation of the UE. The operations of block 1215 may be performed in accordance with examples as disclosed herein. In some examples, aspects of the operations of 1215 may be performed by a transmitting component 625 as described herein with reference to FIG. 6.

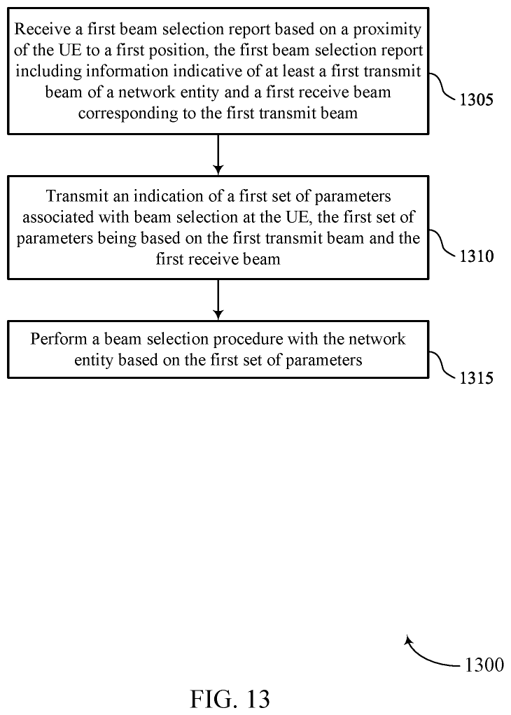

FIG. 13 shows a flowchart illustrating a method 1300 that supports fast beam selection via UE Rx beam selection reporting in accordance with aspects of the present disclosure. The operations of the method 1300 may be implemented by a UE or its components as described herein. For example, the operations of the method 1300 may be performed by a UE 115 as described herein with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving a first beam selection report based on a proximity of the UE to a first position, the first beam selection report including information indicative of at least a first transmit beam of a network entity and a first receive beam corresponding to the first transmit beam. The operations of block 1305 may be performed in accordance with examples as disclosed herein. In some examples, aspects of the operations of 1305 may be performed by a receiving component 630 as described herein with reference to FIG. 6.

At 1310, the method may include transmitting an indication of a first set of parameters associated with beam selection at the UE, the first set of parameters being based on the first transmit beam and the first receive beam. The operations of block 1310 may be performed in accordance with examples as disclosed herein. In some examples, aspects of the operations of 1310 may be performed by a transmitting component 625 as described herein with reference to FIG. 6.

At 1315, the method may include performing a beam selection procedure with the network entity based on the first set of parameters. The operations of block 1315 may be performed in accordance with examples as disclosed herein. In some examples, aspects of the operations of 1315 may be performed by a performing component 635 as described herein with reference to FIG. 6.

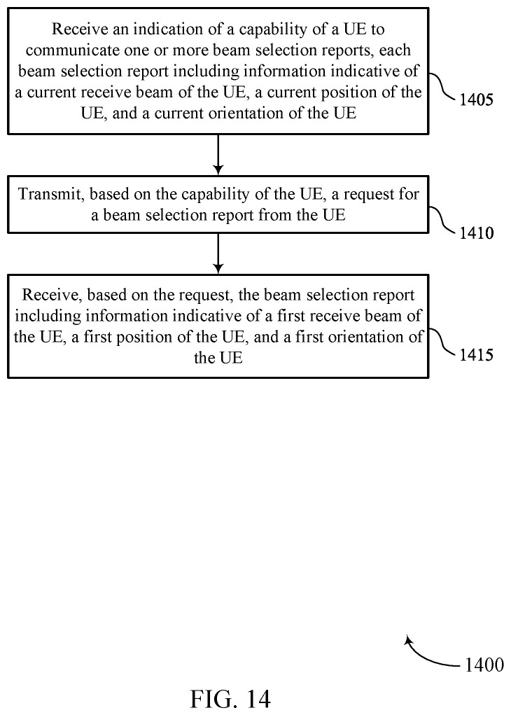

FIG. 14 shows a flowchart illustrating a method 1400 that supports fast beam selection via UE Rx beam selection reporting in accordance with aspects of the present disclosure. The operations of the method 1400 may be implemented by a network entity or its components as described herein. For example, the operations of the method 1400 may be performed by a network entity as described herein with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include receiving an indication of a capability of a UE to communicate one or more beam selection reports, each beam selection report including information indicative of a current receive beam of the UE, a current position of the UE, and a current orientation of the UE. The operations of block 1405 may be performed in accordance with examples as disclosed herein. In some examples, aspects of the operations of 1405 may be performed by a receiving component 1025 as described herein with reference to FIG. 10.

At 1410, the method may include transmitting, based on the capability of the UE, a request for a beam selection report from the UE. The operations of block 1410 may be performed in accordance with examples as disclosed herein. In some examples, aspects of the operations of 1410 may be performed by a transmitting component 1030 as described herein with reference to FIG. 10.

At 1415, the method may include receiving, based on the request, the beam selection report including information indicative of a first receive beam of the UE, a first position of the UE, and a first orientation of the UE. The operations of block 1415 may be performed in accordance with examples as disclosed herein. In some examples, aspects of the operations of 1415 may be performed by a receiving component 1025 as described herein with reference to FIG. 10.

The following provides an overview of aspects of the present disclosure:

Aspect 1: A method for wireless communication by a UE, comprising: transmitting an indication of a capability of the UE to communicate one or more beam selection reports, each beam selection report comprising information indicative of a current receive beam of the UE, a current position of the UE, and a current orientation of the UE; receiving, based at least in part on the capability of the UE, a request for a beam selection report from the UE; and transmitting the beam selection report based at least in part on the request, the beam selection report comprising information indicative of a first receive beam of the UE, a first position of the UE, and a first orientation of the UE.

Aspect 2: The method of aspect 1, further comprising: receiving, based at least in part on the capability of the UE, a control message including information indicative of requested granularities for receive beams reported by the UE, positions reported by the UE, and orientations reported by the UE, wherein each of the first receive beam of the UE, the first position of the UE, and the first orientation of the UE are in accordance with the requested granularities.

Aspect 3: The method of aspect 2, wherein the control message further includes information indicative of a granularity of a transmit beam, of a network entity, to be reported by the network entity.

Aspect 4: The method of any of aspects 1-3, wherein the beam selection report is transmitted at a first time, the method further comprising: transmitting a second beam selection report at a second time based at least in part on a time periodicity associated with the one or more beam selection reports, the second beam selection report comprising information indicative of a second receive beam of the UE at the second time, a second position of the UE at the second time, and a second orientation of the UE at the second time.

Aspect 5: The method of any of aspects 1-4, wherein the beam selection report is transmitted in accordance with one or both of the first position or the first orientation being within a threshold distance or orientation of a first tagged position or a first tagged orientation, respectively, the method further comprising: transmitting a second beam selection report based at least in part on one or both of a second position of the UE or a second orientation of the UE being within the threshold distance or orientation of a second tagged position or a second tagged orientation, respectively.

Aspect 6: The method of any of aspects 1-5, further comprising: receiving a second beam selection report based at least in part on the current position of the UE becoming within a threshold distance of a second position, the second beam selection report comprising information indicative of at least a transmit beam of a network entity and a receive beam corresponding to the transmit beam; transmitting an indication of a first set of parameters associated with beam selection at the UE, the first set of parameters being based at least in part on the transmit beam and the receive beam; and performing a beam selection procedure with the network entity based at least in part on the first set of parameters.

Aspect 7: The method of aspect 6, wherein the second beam selection report further includes information indicative of the second position, a second orientation, and a timestamp corresponding to a third beam selection report via which the receive beam, the second position, and the second orientation is reported.

Aspect 8: The method of aspect 7, further comprising: selecting the first set of parameters based at least in part on the transmit beam, the receive beam, the second position, the second orientation, and the timestamp, wherein the first set of parameters include a transmit beam search window, a receive beam search window, a transmit beam window center, and a receive beam window center.

Aspect 9: The method of any of aspects 1-8, wherein the request is received via a DCI message and the beam selection report is transmitted via a UCI message.

Aspect 10: The method of any of aspects 1-9, wherein information indicative of the first position of the UE and information indicative of the first orientation of the UE comprises coordinate information, elevation information, azimuth information, or any combination thereof, and information indicative of the first receive beam comprises an indication of a quantity of receive antennas.

Aspect 11: A method for wireless communication by a UE, comprising: receiving a first beam selection report based at least in part on a proximity of the UE to a first position, the first beam selection report comprising information indicative of at least a first transmit beam of a network entity and a first receive beam corresponding to the first transmit beam; transmitting an indication of a first set of parameters associated with beam selection at the UE, the first set of parameters being based at least in part on the first transmit beam and the first receive beam; and performing a beam selection procedure with the network entity based at least in part on the first set of parameters.

Aspect 12: The method of aspect 11, wherein the first beam selection report further includes information indicative of the first position, a first orientation, and a first timestamp corresponding to a second beam selection report via which the first receive beam, the first position, and the first orientation is reported.

Aspect 13: The method of aspect 12, further comprising: selecting the first set of parameters based at least in part on the first transmit beam, the first receive beam, the first position, the first orientation, and the first timestamp, wherein the first set of parameters include a first transmit beam search window, a first receive beam search window, a first transmit beam window center, and a first receive beam window center.

Aspect 14: The method of aspect 13, wherein respective sizes of the first transmit beam search window and the first receive beam search window are associated with the proximity of a current position of the UE to the first position, a similarity of a current orientation of the UE to the first orientation, and a time duration between the first timestamp and a time at which the first beam selection report is received by the UE.

Aspect 15: The method of any of aspects 13-14, wherein the first transmit beam window center is the first transmit beam and the first receive beam window center is the first receive beam.

Aspect 16: The method of any of aspects 12-15, wherein information indicative of the first position and information indicative of the first orientation comprises coordinate information, elevation information, azimuth information, or any combination thereof, and information indicative of the first receive beam comprises an indication of a quantity of receive antennas.

Aspect 17: The method of any of aspects 11-16, further comprising: receiving a second beam selection report based at least in part on the UE becoming within a threshold distance to a second position, the second beam selection report comprising information indicative of at least a second transmit beam of the network entity and a second receive beam corresponding to the second transmit beam; transmitting an indication of a second set of parameters associated with the beam selection at the UE, the second set of parameters being based at least in part on the second transmit beam and the second receive beam; and performing a second beam selection procedure with the network entity based at least in part on the second set of parameters associated with the beam selection at the UE.

Aspect 18: The method of any of aspects 11-17, further comprising: transmitting an indication of a capability of the UE to communicate one or more beam selection reports, each beam selection report comprising information indicative of a current receive beam of the UE, a current position of the UE, and a current orientation of the UE; receiving, based at least in part on the capability of the UE, a request for a beam selection report from the UE; and transmitting the beam selection report based at least in part on the request, the beam selection report comprising information indicative of a second receive beam of the UE, a second position of the UE, and a second orientation of the UE.

Aspect 19: The method of aspect 18, further comprising: receiving, based at least in part on the capability of the UE, a control message including information indicative of requested granularities for receive beams reported by the UE, positions reported by the UE, and orientations reported by the UE, wherein each of the second receive beam of the UE, the second position of the UE, and the second orientation of the UE are in accordance with the requested granularities.

Aspect 20: The method of any of aspects 11-19, wherein the UE receives the first beam selection report based at least in part on a current position of the UE becoming within a threshold distance to the first position.

Aspect 21: A method for wireless communication by a network entity, comprising: receiving an indication of a capability of a UE to communicate one or more beam selection reports, each beam selection report comprising information indicative of a current receive beam of the UE, a current position of the UE, and a current orientation of the UE; transmitting, based at least in part on the capability of the UE, a request for a beam selection report from the UE; and receiving, based at least in part on the request, the beam selection report comprising information indicative of a first receive beam of the UE, a first position of the UE, and a first orientation of the UE.

Aspect 22: The method of aspect 21, further comprising: storing information associated with the beam selection report in a database of the network entity, wherein the network entity associates, via the database, the first receive beam of the UE and a first transmit beam of the network entity used to communicate with the UE with the first position of the UE, the first orientation of the UE, and a first timestamp at which the beam selection report is received.

Aspect 23: The method of aspect 22, further comprising: transmitting, to a second UE, a second beam selection report based at least in part on a second position of the second UE becoming within a threshold distance of the first position, the second beam selection report comprising information indicative of at least the first transmit beam and the first receive beam; receiving an indication of a first set of parameters associated with beam selection at the second UE, the first set of parameters being based at least in part on the first transmit beam and the first receive beam; and performing a beam selection procedure with the second UE based at least in part on the first set of parameters.

Aspect 24: The method of aspect 23, wherein the second beam selection report further includes information indicative of the first position, the first orientation, and the first timestamp.

Aspect 25: The method of any of aspects 23-24, wherein the first set of parameters include a first transmit beam search window, a first receive beam search window, a first transmit beam window center, and a first receive beam window center.

Aspect 26: The method of aspect 25, wherein respective sizes of the first transmit beam search window and the first receive beam search window are associated with a proximity of the second position of the second UE to the first position, a similarity of a second orientation of the second UE to the first orientation, and a time duration between the first timestamp and a time at which the second beam selection report is received by the second UE.

Aspect 27: The method of any of aspects 25-26, wherein the first transmit beam window center is the first transmit beam and the first receive beam window center is the first receive beam.

Aspect 28: The method of any of aspects 21-27, further comprising: transmitting, to the UE and based at least in part on the capability of the UE, a control message including information indicative of requested granularities for receive beams reported by the UE, positions reported by the UE, and orientations reported by the UE, wherein each of the first receive beam of the UE, the first position of the UE, and the first orientation of the UE are in accordance with the requested granularities.

Aspect 29: The method of aspect 28, wherein the control message further includes information indicative of a granularity of a transmit beam, of the network entity, to be reported by the network entity.

Aspect 30: The method of any of aspects 21-29, wherein the beam selection report is received at a first time, the method further comprising: receiving a second beam selection report at a second time based at least in part on a time periodicity associated with the one or more beam selection reports, the second beam selection report comprising information indicative of a second receive beam of the UE at the second time, a second position of the UE at the second time, and a second orientation of the UE at the second time.

Aspect 31: The method of any of aspects 21-30, wherein the beam selection report is received in accordance with one or both of the first position or the first orientation being within a threshold distance or orientation of a first tagged position or a first tagged orientation, respectively, the method further comprising: receiving a second beam selection report based at least in part on one or both of a second position of the UE or a second orientation of the UE being within the threshold distance or orientation of a second tagged position or a second tagged orientation, respectively.

Aspect 32: The method of any of aspects 21-31, further comprising: receiving a plurality of beam selection reports from a plurality of UEs including the UE, each of the plurality of beam selection reports comprising information indicative of a respective current receive beam, a respective current position, and a respective current orientation of each respective UE of the plurality of UEs; generating a map associated with a plurality of positions and a plurality of orientations in accordance with the plurality of beam selection reports, wherein the map associates a position and orientation pair to a UE receive beam and a network entity transmit beam; and transmitting one or more beam selection reports to one or more UEs of the plurality of UEs, respectively, in accordance with the one or more UEs moving to one or more positions of the plurality of positions, respectively.

Aspect 33: The method of any of aspects 21-32, wherein the request is transmitted via a DCI message and the beam selection report is received via a UCI message.

Aspect 34: The method of any of aspects 21-33, wherein information indicative of the first position of the UE and information indicative of the first orientation of the UE includes coordinate information, elevation information, azimuth information, or any combination thereof, and information indicative of the first receive beam comprises an indication of a quantity of receive antennas.

Aspect 35: A UE, comprising at least one processor, and at least one memory coupled with the at least one processor, with instructions stored in the at least one memory, the instructions being executable by the at least one processor, individually or in any combination, to cause the UE to perform a method of any of aspects 1-10.

Aspect 36: A UE, comprising at least one means for performing a method of any of aspects 1-10.

Aspect 37: A non-transitory computer-readable medium storing code for wireless communication, the code comprising instructions executable by at least one processor, individually or in any combination, to perform a method of any of aspects 1-10.

Aspect 38: A UE, comprising at least one processor, and at least one memory coupled with the at least one processor, with instructions stored in the at least one memory, the instructions being executable by the at least one processor, individually or in any combination, to cause the UE to perform a method of any of aspects 11-20.

Aspect 39: A UE, comprising at least one means for performing a method of any of aspects 11-20.

Aspect 40: A non-transitory computer-readable medium storing code for wireless communication, the code comprising instructions executable by at least one processor, individually or in any combination, to perform a method of any of aspects 11-20.

Aspect 41: A network entity, comprising at least one processor, and at least one memory coupled with the at least one processor, with instructions stored in the at least one memory, the instructions being executable by the at least one processor, individually or in any combination, to cause the network entity to perform a method of any of aspects 21-34.

Aspect 42: A network entity, comprising at least one means for performing a method of any of aspects 21-34.

Aspect 43: A non-transitory computer-readable medium storing code for wireless communication, the code comprising instructions executable by at least one processor, individually or in any combination, to perform a method of any of aspects 21-34.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as any combination of computing devices (e.g., any combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
at least one processor; and
at least one memory coupled with the at least one processor, with instructions stored in the at least one memory, the instructions being executable by the at least one processor, individually or in any combination, to cause the UE to:
transmit an indication of a capability of the UE to communicate one or more beam selection reports, each beam selection report comprising information indicative of a current receive beam of the UE, a current position of the UE, and a current orientation of the UE;
receive, based at least in part on the capability of the UE, a request for a beam selection report from the UE; and
transmit the beam selection report based at least in part on the request, the beam selection report comprising information indicative of a first receive beam of the UE, a first position of the UE, and a first orientation of the UE.

2. The UE of claim 1, wherein the instructions are further executable by the at least one processor to cause the UE to:
receive, based at least in part on the capability of the UE, a control message comprising information indicative of requested granularities for receive beams reported by the UE, positions reported by the UE, and orientations reported by the UE, wherein each of the first receive beam of the UE, the first position of the UE, and the first orientation of the UE are in accordance with the requested granularities.

3. The UE of claim 2, wherein the control message further comprises information indicative of a granularity of a transmit beam, of a network entity, to be reported by the network entity.

4. The UE of claim 1, wherein the beam selection report is transmitted at a first time, and the instructions are further executable by the at least one processor to cause the UE to:
transmit a second beam selection report at a second time based at least in part on a time periodicity associated with the one or more beam selection reports, the second beam selection report comprising information indicative of a second receive beam of the UE at the second time, a second position of the UE at the second time, and a second orientation of the UE at the second time.

5. The UE of claim 1, wherein the beam selection report is transmitted in accordance with one or both of the first position or the first orientation being within a threshold distance or orientation of a first tagged position or a first tagged orientation, and the instructions are further executable by the at least one processor to cause the UE to:
transmit a second beam selection report based at least in part on one or both of a second position of the UE or a second orientation of the UE being within the threshold distance or orientation of a second tagged position or a second tagged orientation, respectively.

6. The UE of claim 1, wherein the instructions are further executable by the at least one processor to cause the UE to:
receive a second beam selection report based at least in part on the current position of the UE becoming within a threshold distance of a second position, the second beam selection report comprising information indicative of at least a transmit beam of a network entity and a receive beam corresponding to the transmit beam;
transmit an indication of a first set of parameters associated with beam selection at the UE, the first set of parameters being based at least in part on the transmit beam and the receive beam; and
perform a beam selection procedure with the network entity based at least in part on the first set of parameters.

7. The UE of claim 6, wherein the second beam selection report further comprises information indicative of the second position, a second orientation, and a timestamp corresponding to a third beam selection report via which the receive beam, the second position, and the second orientation is reported.

8. The UE of claim 7, wherein the instructions are further executable by the at least one processor to cause the UE to:
select the first set of parameters based at least in part on the transmit beam, the receive beam, the second position, the second orientation, and the timestamp, wherein the first set of parameters comprises a transmit beam search window, a receive beam search window, a transmit beam window center, and a receive beam window center.

9. The UE of claim 1, wherein information indicative of the first position of the UE and information indicative of the first orientation of the UE comprises coordinate information, elevation information, azimuth information, or any combination thereof, and information indicative of the first receive beam comprises an indication of a quantity of receive antennas.

10. A user equipment (UE), comprising:
at least one processor; and
at least one memory coupled with the at least one processor, with instructions stored in the at least one memory, the instructions being executable by the at least one processor, individually or in any combination, to cause the UE to:
receive a first beam selection report based at least in part on a proximity of the UE to a first position, the first beam selection report comprising information indicative of at least a first transmit beam of a network entity and a first receive beam corresponding to the first transmit beam;
transmit an indication of a first set of parameters associated with beam selection at the UE, the first set of parameters being based at least in part on the first transmit beam and the first receive beam; and
perform a beam selection procedure with the network entity based at least in part on the first set of parameters.

11. The UE of claim 10, wherein the first beam selection report further comprises information indicative of the first position, a first orientation, and a first timestamp corresponding to a second beam selection report via which the first receive beam, the first position, and the first orientation is reported.

12. The UE of claim 11, wherein the instructions are further executable by the at least one processor to cause the UE to:
select the first set of parameters based at least in part on the first transmit beam, the first receive beam, the first position, the first orientation, and the first timestamp, wherein the first set of parameters comprises a first transmit beam search window, a first receive beam search window, a first transmit beam window center, and a first receive beam window center.

13. The UE of claim 12, wherein respective sizes of the first transmit beam search window and the first receive beam search window are associated with the proximity of a current position of the UE to the first position, a similarity of a current orientation of the UE to the first orientation, and a time duration between the first timestamp and a time at which the first beam selection report is received by the UE.

14. The UE of claim 12, wherein the first transmit beam window center is the first transmit beam and the first receive beam window center is the first receive beam.

15. The UE of claim 11, wherein information indicative of the first position and information indicative of the first orientation comprises coordinate information, elevation information, azimuth information, or any combination thereof, and information indicative of the first receive beam comprises an indication of a quantity of receive antennas.

16. The UE of claim 10, wherein the instructions are further executable to cause the UE to:
receive a second beam selection report based at least in part on the UE becoming within a threshold distance to a second position, the second beam selection report comprising information indicative of at least a second transmit beam of the network entity and a second receive beam corresponding to the second transmit beam;
transmit an indication of a second set of parameters associated with the beam selection at the UE, the second set of parameters being based at least in part on the second transmit beam and the second receive beam; and
perform a second beam selection procedure with the network entity based at least in part on the second set of parameters associated with the beam selection at the UE.

17. The UE of claim 10, wherein the instructions are further executable by the at least one processor to cause the UE to:
transmit an indication of a capability of the UE to communicate one or more beam selection reports, each beam selection report comprising information indicative of a current receive beam of the UE, a current position of the UE, and a current orientation of the UE;
receive, based at least in part on the capability of the UE, a request for a beam selection report from the UE; and
transmit the beam selection report based at least in part on the request, the beam selection report comprising information indicative of a second receive beam of the UE, a second position of the UE, and a second orientation of the UE.

18. The UE of claim 17, wherein the instructions are further executable by the at least one processor to cause the UE to:
receive, based at least in part on the capability of the UE, a control message comprising information indicative of requested granularities for receive beams reported by the UE, positions reported by the UE, and orientations reported by the UE, wherein each of the second receive beam of the UE, the second position of the UE, and the second orientation of the UE are in accordance with the requested granularities.

19. The UE of claim 10, wherein the UE receives the first beam selection report based at least in part on a current position of the UE becoming within a threshold distance to the first position.

20. A network entity, comprising:
at least one processor; and
at least one memory coupled with the at least one processor, with instructions stored in the at least one memory, the instructions being executable by the at least one processor, individually or in any combination, to cause the network entity to:
receive an indication of a capability of a user equipment (UE) to communicate one or more beam selection reports, each beam selection report comprising information indicative of a current receive beam of the UE, a current position of the UE, and a current orientation of the UE;
transmit, based at least in part on the capability of the UE, a request for a beam selection report from the UE; and
receive, based at least in part on the request, the beam selection report comprising information indicative of a first receive beam of the UE, a first position of the UE, and a first orientation of the UE.

21. The network entity of claim 20, wherein the instructions are further executable by the at least one processor to cause the network entity to:
store information associated with the beam selection report in a database of the network entity, wherein the network entity associates, via the database, the first receive beam of the UE and a first transmit beam of the network entity used to communicate with the UE with the first position of the UE, the first orientation of the UE, and a first timestamp at which the beam selection report is received.

22. The network entity of claim 21, wherein the instructions are further executable by the at least one processor to cause the network entity to:
transmit, to a second UE, a second beam selection report based at least in part on a second position of the second UE becoming within a threshold distance of the first position, the second beam selection report comprising information indicative of at least the first transmit beam and the first receive beam;
receive an indication of a first set of parameters associated with beam selection at the second UE, the first set of parameters being based at least in part on the first transmit beam and the first receive beam; and
perform a beam selection procedure with the second UE based at least in part on the first set of parameters.

23. The network entity of claim 22, wherein the second beam selection report further comprises information indicative of the first position, the first orientation, and the first timestamp.

24. The network entity of claim 22, wherein the first set of parameters comprises a first transmit beam search window, a first receive beam search window, a first transmit beam window center, and a first receive beam window center.

25. The network entity of claim 24, wherein respective sizes of the first transmit beam search window and the first receive beam search window are associated with a proximity of the second position of the second UE to the first position, a similarity of a second orientation of the second UE to the first orientation, and a time duration between the first timestamp and a time at which the second beam selection report is received by the second UE.

26. The network entity of claim 24, wherein the first transmit beam window center is the first transmit beam and the first receive beam window center is the first receive beam.

27. The network entity of claim 20, wherein the instructions are further executable by the at least one processor to cause the network entity to:
transmit, to the UE and based at least in part on the capability of the UE, a control message comprising information indicative of requested granularities for receive beams reported by the UE, positions reported by the UE, and orientations reported by the UE, wherein each of the first receive beam of the UE, the first position of the UE, and the first orientation of the UE are in accordance with the requested granularities.

28. The network entity of claim 27, wherein the control message further comprises information indicative of a granularity of a transmit beam, of the network entity, to be reported by the network entity.

29. The network entity of claim 20, wherein the instructions are further executable by the at least one processor to cause the network entity to:
receive a plurality of beam selection reports from a plurality of UEs comprising the UE, each of the plurality of beam selection reports comprising information indicative of a respective current receive beam, a respective current position, and a respective current orientation of each respective UE of the plurality of UEs;
generate a map associated with a plurality of positions and a plurality of orientations in accordance with the plurality of beam selection reports, wherein the map associates a position and orientation pair to a UE receive beam and a network entity transmit beam; and
transmit one or more beam selection reports to one or more UEs of the plurality of UEs, respectively, in accordance with the one or more UEs moving to one or more positions of the plurality of positions, respectively.

30. A method for wireless communication by a user equipment (UE), comprising:
transmitting an indication of a capability of the UE to communicate one or more beam selection reports, each beam selection report comprising information indicative of a current receive beam of the UE, a current position of the UE, and a current orientation of the UE;
receiving, based at least in part on the capability of the UE, a request for a beam selection report from the UE; and
transmitting the beam selection report based at least in part on the request, the beam selection report comprising information indicative of a first receive beam of the UE, a first position of the UE, and a first orientation of the UE.
